(19) United States
(12) Patent Application Publication
(10) Pub. No.: US 2019/0233782 A1
(43) Pub. Date: Aug. 1, 2019

(54) UNITARY LAUNDRY DETERGENT ARTICLE HAVING FIBROUS SUBSTRATES

(71) Applicant: The Procter & Gamble Company, Cincinnati, OH (US)

(72) Inventors: Mark Robert SIVIK, Mason, OH (US); Kristi Lynn FLITER, Harrison, OH (US); Frank William DENOME, CINCINNATI, OH (US)

(21) Appl. No.: 16/253,259

(22) Filed: Jan. 22, 2019

Related U.S. Application Data
(60) Provisional application No. 62/622,426, filed on Jan. 26, 2018.
(60) Provisional application No. 62/727,104, filed on Sep. 5, 2018.

(51) Int. Cl. C11D 17/04; C11D 11/00; C11D 3/42

(52) U.S. Cl. CPC C11D 17/043; C11D 1/24; C11D 3/42; C11D 11/0017

(57) ABSTRACT

A method of laundering fabric having the following steps: a) providing a water-soluble unit dose article; b) providing a surfactant; c) diluting a dose of the water-soluble unit does article in water by a factor of greater than about 500 to form a wash liquor, the resulting wash liquor having from about 50 ppm to about 2800 ppm of surfactant; and d) washing one or more fabrics in the resulting wash liquor.

### FIELD OF THE INVENTION

Described herein is a household care composition, which delivers fabric hueing agent onto fabric, in the form of a water-soluble unit dose article comprising a water-soluble fibrous structure and household care active agents, as well as methods for treating fabrics using the same.

### BACKGROUND OF THE INVENTION

Cleaning compositions come in a number of product forms, such as granules (e.g., powders), liquids, and water-soluble unit dose articles (e.g., pouches), with each form having its advantages and disadvantages. Granular cleaning compositions generally provide good cleaning performance at an affordable cost and conserve resources during shipping due to the low water content of the compositions. However, granular cleaning compositions may be difficult to properly dose, many times leading to over or under dosing. Additionally, granular cleaning compositions can easily be spilled during use or can absorb moisture from the ambient air to form clumps (i.e., caking). Granular cleaning compositions are also known to exhibit dissolution problems, especially in cold temperature laundering solutions (e.g., less than about 30° C.). Liquid laundry detergents are often preferred over granular cleaning compositions because of the convenience and aesthetics of the liquid form. Liquid laundry detergents also generally provide good cleaning performance at an affordable cost. However, liquid laundry detergents, like granular cleaning compositions, may also be difficult to properly dose, many times leading to over or under dosing. Similar to granular cleaning compositions, liquid laundry detergents may also be spilled during use. Liquid laundry detergents also contain high water content leading to a larger expenditure in resources during shipping. Liquid laundry detergents also may have formulation and stability challenges.

More recently, water-soluble unit dose articles (e.g., pouches) have come to the market and have been met with acceptance from consumers, as they provide a convenient, efficient, and clean way of dosing a fabric or hard surface treatment composition. Water-soluble unit dose articles provide a measured dosage of a treatment composition, thereby avoiding over or under dosing. Water-soluble unit dose articles have integral or unitary structures that significantly lower the risk of spillage, leakage, or caking. Unlike liquid laundry compositions, water-soluble unit dose articles contain little or no water, which allow for greater concentration of product and greater ease of transporting and handling, with little or no risk of leakage. Further, they are chemically and physically stable during shipment and storage. They also contain active agents inside of the article so that active agents are not in contact with the user. Consequently, they have become more and more commercially available and popular with consumers.

Incorporation of shading or hueing agents into the conventional powder and liquid laundry detergents laundry detergent compositions for improving the aesthetic appearance of treated fabrics is also known. Such fabric hueing agents impart to the treated fabrics a slightly colored hue or shade, e.g., a green, blue or violet hue, that can effectively increase the apparent whiteness of such treated fabrics and renders them aesthetically more pleasing to the eyes of the consumers than fabrics without such hue. However, incorporation of fabric hueing agents into water-soluble film articles may provide several challenges. For example, dissolution problems (especially in cold temperature laundering solutions which are more popular with consumers today) are still present in film-based water-soluble unit dose articles. If the film-based unit dose articles do not fully dissolve, fabric hueing agents in the film will migrate as films contain plasticizer. If the film does not dissolve completely and the fabric hueing agent is bound to the film, then the fabric hueing agent may appear on fabrics as unwanted stains. Additionally, proper dispersal of fabric hueing agents requires a certain level of surfactant to be present. However, placing surfactant in close contact with fabric hueing agent may lead to formulation challenges such as compatibility. Too little surfactant present may lead to the resulting color becoming too dark for the consumer's liking. Conversely, too much surfactant present may lead to less fabric hueing agent being dosed onto the fabric than is desirable.

In sum, it is challenging to provide a water-soluble unit dose article that has a high concentration of fabric hueing agent, the unit dose article is fully dissolvable, where the fabric hueing agent is properly dispersed within the wash, is contained inside the article and is not in contact the user, and provides improved dissolution, especially in stressed washing conditions, e.g., cold temperature washing. Surprisingly, it has been found that a water-soluble unit dose article comprising a multi-ply, multi-layer water-soluble fibrous structure, a fabric hueing agent contained between the outermost plies, and providing a surfactant within the wash or within the outermost plies, provides proper dispersal of the fabric hueing agent, and improved cleaning and dissolution.

### SUMMARY OF THE INVENTION

The present disclosure relates to a method of laundering fabric comprising the following steps: a) providing a water-soluble unit dose article; b) providing a surfactant; c) diluting a dose of the water-soluble unit does article in water by a factor of greater than about 500 to form a wash liquor, the resulting wash liquor comprising from about 50 ppm to about 2800 ppm of surfactant; and d) washing one or more fabrics in the resulting wash liquor. The water-soluble unit dose article comprises a plurality of fibrous elements, comprising at least a first ply and a second ply in juxtaposed relation. The fibrous structure comprises at least one fabric hueing agent between the first ply and the second ply.

The present disclosure further relates to a water-soluble unit dose article comprises a plurality of fibrous elements, comprising at least a first ply and a second ply in juxtaposed relation. The fibrous structure comprises at least one fabric hueing agent between the first ply and the second ply. The present disclosure further relates to the unit dose article having a third ply in between the first ply and the second ply comprising from about 0.01% to about 30% by weight on a dry fibrous element basis of said fabric hueing agent.

### BRIEF DESCRIPTION OF THE DRAWINGS

FIG. 1 shows a perspective view of a water-soluble unit dose article having a first ply and a second ply in juxtaposed relation.

FIG. 2 shows a cross-section side view of a water-soluble unit dose article having a first ply and a second ply in juxtaposed relation.

FIG. 3 shows a cross-section side view of a water-soluble unit dose article having a first ply and a second ply in juxtaposed relation, the first ply having an outward-facing layer and an inward-facing layer and the second ply having an outward-facing layer and an inward-facing layer.

FIG. 4 shows a perspective view of a water-soluble unit dose article having a first ply and a second ply in juxtaposed relation and a third ply between the first ply and the second ply.

FIG. 5 shows a cross-section side view of a water-soluble unit dose article having a first ply and a second ply in juxtaposed relation and a third ply between the first ply and the second ply.

FIG. 6 shows a cross-section side view of a water-soluble unit dose article having a first ply and a second ply in juxtaposed relation, where a portion of the first ply is joined to a portion of the second ply.

FIG. 7 shows a cross-section side view of a water-soluble unit dose article having a first ply and a second ply in juxtaposed relation, and a third ply between the first ply and the second ply, where a portion of the first ply is joined to a portion of the second ply.

FIG. 8 shows a cross-section side view of a water-soluble unit dose article having a first ply and a second ply in juxtaposed relation, and a third ply between the first ply and the second ply, the first ply and the second ply are joined to one another through the third ply.

### DETAILED DESCRIPTION OF THE INVENTION

### Definitions

Features and benefits of the present invention will become apparent from the following description, which includes examples intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the “ambient conditions” refers to 23° C.±1.0° C. and a relative humidity of 50%±2%.

As used herein, the term “discrete” refers to particles that are structurally distinctive from each other either under naked human eyes or under electronic imaging devices, such as scanning electron microscope (SEM) and transmission electron microscope (TEM). Preferably, the discrete particles of the present invention are structurally distinctive from each other under naked human eyes.

The terms “fibrous element” and “filaments” are used interchangeably here to refer to elongated particles having a length greatly exceeding its average cross-sectional diameter, i.e., a length-to-diameter aspect ratio of at least 10:1, and preferably such elongated particles have an average cross-sectional diameter of no more than 1 mm

As used herein, “Hydrophilic Index” or “HI” of a surfactant is calculated by the following equation:

$$HI = \frac{{M}_{h}}{{M}_{T}} \times 20$$

wherein Mₕ is the molecular weight of all hydrophilic groups in the surfactant, wherein M_{T} is the total molecular weight of the surfactant. Both Mₕ and M_{T} refer to weight average molecular weights. For example, linear alkylbenzene sulfonate with an average alkyl chain length of about 11.8 has a HI value of about 4.97. For another example, C₁₂-C₁₄ alkyl sulfate has a HI value of about 6.98. For yet another example, C₁₂-C₁₄ alkyl ethoxylated sulfate with an average ethoxylation degree of about 1 has a HI value of about 8.78, and C₁₂-C₁₄ alkyl ethoxylated sulfate with an average ethoxylation degree of about 3 has a HI value of about 11.57. For still another example, C₁₄-C₁₅ alkyl ethoxylated alcohol with an average ethoxylation degree of about 7 has a HI value of about 12.73, and C₁₂-C₁₄ alkyl ethoxylated alcohol with an average ethoxylation degree of about 9 has a HI value of about 14.72.

As used herein, the terms “include,” “includes” and “including” are meant to be non-limiting.

As used herein, the term “particle” refers to a solid matter of minute quantity, such as a powder, granule, encapsulate, microcapsule, and/or prill. The particles of the present invention can be spheres, rods, plates, tubes, squares, rectangles, discs, stars or flakes of regular or irregular shapes, but they are non-fibrous.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

As used herein, the term “unitary” refers to a structure containing a plurality of distinctive parts that are combined together to form a visually coherent and structurally integral article.

As used herein, the phrases “water-soluble unit dose article,” “water-soluble fibrous element,” “water-soluble fibrous structure,” and “water-soluble particle” means that the unit dose article, fibrous element, fibrous structure or particle is soluble or dispersible in water, and preferably has a water-solubility of at least 50%, preferably at least 75% or even at least 95%, as measured by the method set out hereafter using a glass-filter with a maximum pore size of 20 microns: 50 grams ±0.1 gram of pouch material is added in a pre-weighed 400 mL beaker and 245 mL±1 mL of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

It should be understood that the term “comprise” includes also embodiments where the term “comprises” includes “consists of” or “consists essentially of.”

In this description, all concentrations and ratios are on a weight basis of the composition unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average molecular weight unless otherwise specifically noted.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Fabric hueing agents (sometimes referred to as shading, bluing or whitening agents) may be used when laundering a fabric to provide whiteness or brightness of color benefit. This is because fabric hueing agents typically provides a blue or violet shade to fabric. Hueing agents can be used either alone or in combination to create a specific shade of hueing and/or to shade different fabric types. Surfactants may be used when laundering a fabric to act as a detergent, functioning to help rid fabric of soils and stains.

Without wishing to be bound by theory, it has been found that when laundering one or more fabrics, having surfactant in conjunction with fabric hueing agent may assist in dispersing the fabric hueing agent throughout the wash. Without wishing to be bound by theory, it has been found that when a pre-determined amount of fabric hueing agent is added to the wash without a minimum level of surfactant corresponding to that pre-determined level of fabric hueing agent present, staining of the fabric may occur. What is meant by staining is that the fabric hueing agent deposits onto one or more of the fabrics in such a way as to leave a noticeable coloring (typically blue or violet shade) on the fabric that is displeasing to the user. Without wishing to be bound by theory, staining may occur due to the fabric hueing agent not being properly dispersed in the wash which may lead to deposition of fabric hueing agent on a concentrated area of one or more fabrics.

Without wishing to be bound by theory, it has been found that when a pre-determined amount of fabric hueing agent is added to the wash along in conjunction with a level of surfactant exceeding a maximum level of surfactant corresponding to the pre-determined level of fabric hueing agent, the fabric hueing agent may be suspended within the wash liquor rather than depositing onto the one or more fabrics, which may lead to less of a noticeable brightness and/or whitening benefit for users.

Without wishing to be bound by theory, it has been found that when a particular range of surfactant corresponding to the pre-determined range of fabric hueing agent is present in the wash, the fabric hueing agent may properly disperse onto the one or more fabrics as to provide a brightening and/or whitening benefit without the negative result of staining When the fabric hueing agent is delivered to the wash by means of a water-soluble unit dose article, surfactant may be present within the same unit dose article and/or within a delivery system separate from the unit dose article having the fabric hueing agent. Such delivery systems may be, for example, in the form of a liquid, a granule (e.g., a powder), and/or a unit dose article. It is also contemplated that a suitable level of surfactant may be present from a previous wash cycle.

These water-soluble unit dose articles comprising fibrous structures can be dissolved under various wash conditions, e.g.,low temperature, low water and/or short wash cycles or cycles where consumers have been overloading the machine, especially with items with high water absorption capacity, while providing sufficient delivery of active agents for the intended effect on the target consumer substrates (with similar performance as today's liquid products). Unlike granular compositions and web-based unit dose articles, fiber-based unit dose articles more readily dissolve in the wash, including in cold temperature wash conditions (e.g., less than about 30° C.). The fibrous structure provides structural integrity for easy transport and packaging; the convenience of simple dosing unlike liquid and granular detergents; and can be produced in an economical manner by spinning fibers comprising active agents. The water-soluble unit dose articles described herein also have improved cleaning performance.

Further, a fabric hueing agent may be incorporated into a fibrous structure without the problem of migration, such as what occurs within film-based unit dose articles. When fabric hueing agent is incorporated into the fibrous elements, the result is a very soluble non-staining fiber. Incorporating fabric hueing dye directly into the fibrous elements as the fibrous elements are being formed is preferred as spraying fabric hueing agent onto the fibrous elements may cause fabric hueing agent to migrate.

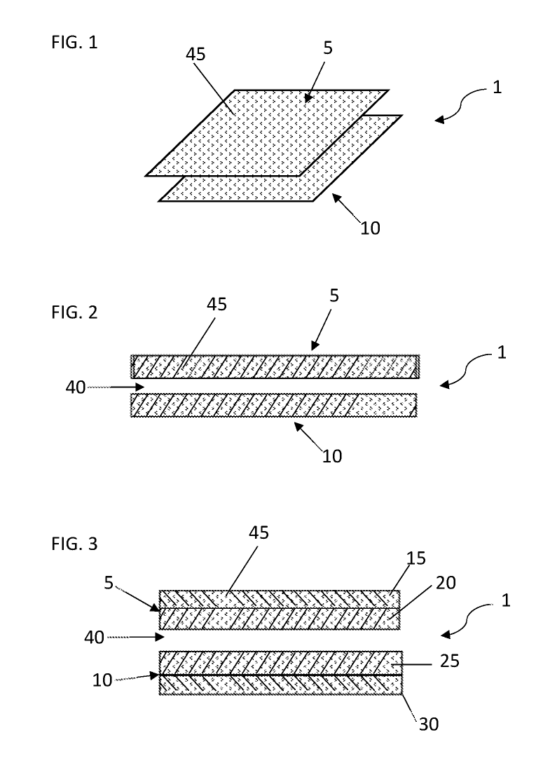

FIG. 1 shows a perspective view of a water-soluble unit dose article 1. The water-soluble unit dose article 1 may be used to treat fabrics. A user may place the water-soluble unit dose article 1 into a washing machine along with fabrics to treat the fabrics. The water-soluble unit dose article 1 may comprise a water-soluble fibrous structure. The water-soluble fibrous structure may comprise a plurality of fibrous elements 45. The fibrous elements 45 can be associated with one another to form a structure, such as a ply. The water-soluble fibrous structure may be a multi-ply structure having one or more plies. The fibrous structure may comprise a first ply 5 and a second ply 10. The first ply 5 and the second ply 10 may be in juxtaposed relation. The first ply 5 and the second ply 10 may be in such a configuration as to form an interior 40 of the water-soluble unit dose article 1. Household care active agents may be comprised between the first ply 5 and the second ply 10, such as, for example, a fabric hueing agent. Household care active agents may be comprised within the interior 40 formed by the first ply 5 and the second ply 10, such as, for example, a fabric hueing agent.

FIG. 2 shows a cross-section side view of a water-soluble unit dose article 1 having a first ply 5 and a second ply 10 in juxtaposed relation to form an interior 40 of a water-soluble unit dose article 1.

FIG. 3 shows a cross-section side view of a water-soluble unit dose article 1 having a first ply 5 and a second ply 10 in juxtaposed relation. The fibrous structure may comprise one or more layers, the layers together forming the ply. The layers forming the ply may comprise a plurality of fibrous elements 45. A ply having a plurality of layers can be formed by depositing a plurality of fibrous elements 45 having a distinguishing characteristic to form a first layer and then depositing a second layer of fibrous elements 45 on top of the first layer. As shown in FIG. 3, the first ply 5 may comprise at least two superposed layers, a first ply inward-facing layer 20 and a first ply outward-facing layer 15 contiguous with the first ply inward-facing layer 20. The second ply 10 may comprise at least two superposed layers, a second ply inward-facing layer 25 and a second ply outward-facing layer 30 contiguous with the second ply inward-facing layer 25. As shown in FIG. 3, the first ply 5 and the second ply 10 may be oriented in the unit dose article 1 such that the first ply outward-facing layer 15 and the second ply outward-facing layer 30 face away from one another. As further shown in FIG. 3, the first ply 5 and the second ply 10 may be oriented in the unit dose article 1 so that the first ply inward-facing layer 20 and the second ply inward-facing layer 25 may face one another. The first ply 5 and the second ply 10 may be the outermost plies of the unit dose article 1. When the first ply 5 and the second ply 10 are the outermost plies of the unit dose article 1, the first ply outward-facing layer 15 and the second ply outward-facing layer 30 may be the exposed surfaces of the unit dose article 1. The exposed surfaces of the unit dose article 1 may be what the user touches or holds onto in order to transport the unit dose article 1 from one location to another. As exemplified in FIG. 3, the first ply inward-facing layer 20 and the second ply inward-facing layer 25 may form the bounds of the interior 40. Household care active agents may be comprised between the first ply inward-facing layer 20 and the second ply inward-facing layer 25, such as, for example, a fabric hueing agent. Household care active agents may be comprised within the interior 40 formed by the bounds set by the first ply inward-facing layer 20 and the second ply inward-facing layer 25, such as, for example, a fabric hueing agent.

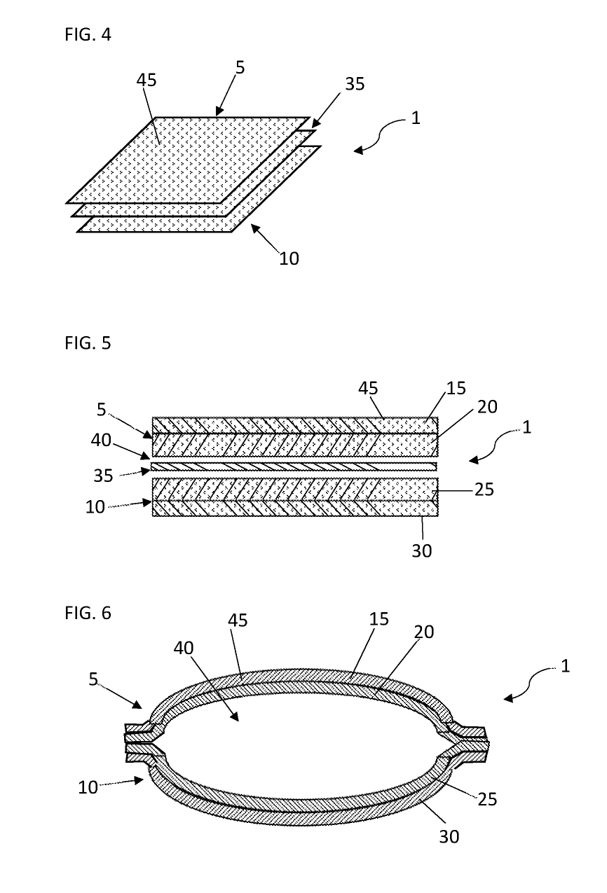

FIGS. 4 and 5 shows a perspective view and a cross-section side view, respectively, of a water-soluble unit dose article 1 having a first ply 5 and a second ply 10 in juxtaposed relation and a third ply 35 between the first ply 5 and the second ply 10. The first ply 5, second ply 10, and third ply 35 each comprise a plurality of fibrous elements 45.

FIG. 6 shows a cross-section side view of a water-soluble unit dose article 1 having a first ply 5 and a second ply 10 in juxtaposed relation, where a portion of the first ply 5 is joined to a portion of the second ply 10 to form a unitary unit dose article 1.

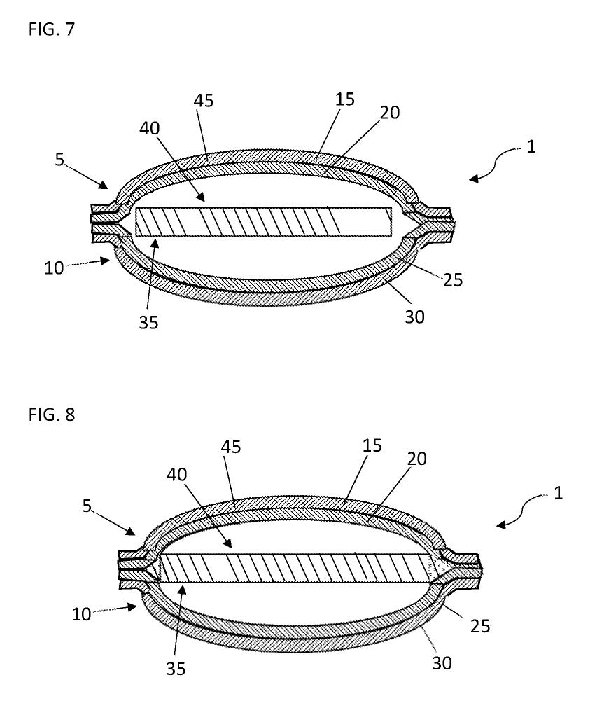

FIG. 7 shows a cross-section side view of a water-soluble unit dose article 1 having a first ply 5 and a second ply 10 in juxtaposed relation, where a portion of the first ply 5 and a portion of the second ply 10 are joined with one another, and a third ply 35 between the first ply 5 and the second ply 10.

FIG. 8 shows a cross-section side view of a water-soluble unit dose article 1 having a first ply 5 and a second ply 10 in juxtaposed relation. The first ply 5 and the second ply 10 are joined to the third ply 35 such that the first ply 5 and the second ply 10 are joined to one another through the third ply 35.

### Method of Laundering a Fabric

The present invention encompasses a method of laundering fabric comprising the steps of:
a) providing a water-soluble unit dose article 1 comprising a multi-ply water-soluble fibrous structure comprising a plurality of fibrous elements 45, said fibrous structure comprising at least a first ply 5 and a second ply 10 in juxtaposed relation, wherein said fibrous structure comprises at least one fabric hueing agent between said first ply 5 and said second ply 10;
b) providing a surfactant;
c) diluting a dose of said water-soluble unit dose article 1 in water by a factor of greater than about 500 to form a wash liquor, the resulting wash liquor comprising from about 50 ppm to about 2800 ppm of surfactant; and
d) washing one or more fabrics with said wash liquor.

The present invention comprises a first step of providing a water-soluble unit dose article 1. The water-soluble unit dose article 1 contemplated by the present invention comprises a multi-ply water-soluble fibrous structure comprising a plurality of fibrous elements 45. The fibrous structure comprises at least a first ply 5 and a second ply 10 in juxtaposed relation. The fibrous structure comprises at least one fabric hueing agent between the first ply 5 and the second ply 10. The unit dose article 1 is further described hereinafter.

The present invention further comprises the step of providing a surfactant. The step of providing a surfactant may occur prior to, after, or concurrently with the step of providing a water-soluble unit dose article 1. It is contemplated that the source of the surfactant may be from a source separate from the unit dose article 1, such as from a liquid detergent, powder detergent, and/or sheet detergent. The source of surfactant may be of any source typically used for laundering fabrics. The source of the surfactant may be the unit dose article 1 contemplated.

The present invention further comprises the step of diluting a dose of the unit dose article 1 in water by a factor of greater than about 500 to form a wash liquor, the resulting wash liquor comprising from about 50 ppm to about 2800 ppm of surfactant. The wash liquor may be an aqueous solution. The dilution factor in the method of the present invention may be by a factor of greater than about 500, by which is meant that one dosage (or volume) of the unit dose article may be mixed with about 500 volumes of water. The dilution factor is preferably less than 2500. Particularly preferred dilution factors may fall within the range of from about 500 to about 1500, more preferably from about 500 to about 1000. Without wishing to be bound by theory, a dilution factor within the above ranges may allow for sufficient dissolution of the water-soluble unit dose article 1 to form the wash liquor. Furthermore, a dilution factor within the above ranges may allow for the concentration of fabric hueing agent within the unit dose article 1 to be mechanically distributed throughout the drum of the washing machine, as well as mechanically moving the one or more fabrics within the drum of the washing machine, such that the fabric hueing agent may be more homogeneously spread throughout the wash liquor and onto the resulting one or more fabrics.

The resulting wash liquor may comprise from about 50 ppm to about 2800 ppm of surfactant. Suitable surfactants are further described hereinafter. The resulting wash liquor may comprise from about 75 ppm to about 1500 ppm of surfactant, preferably from about 100 ppm to about 500 ppm of surfactant. Without wishing to be bound by theory, it has been found that the above ranges of surfactant, when used with the pre-determined amount of fabric hueing agent, are sufficient to disperse the fabric hueing agent throughout the wash liquor and for the fabric hueing agent to properly deposit onto the one or more fabrics without the negative effect of staining. Further, the above ranges of surfactant are of common dosage loads provided on instructions for dosing on many common laundry detergent products, such that the common consumer need not deter from their normal habits of dosing laundry detergent.

The present invention further comprises the step of washing one or more fabrics with the resulting wash liquor. The step of washing one or more fabrics with the resulting wash liquor must come after the steps of providing a water-soluble unit dose article 1, providing a surfactant, and diluting the dose of water-soluble unit dose article 1 in water to form a wash liquor comprising from about 50 ppm to about 2800 ppm of surfactant. This is because the one or more fabrics may not be sufficiently laundered as to result in the benefits of cleaning the fabric and whitening and/or brightening the fabric should the water-soluble unit dose article 1 and the surfactant not already have formed a wash liquor in aqueous solution. Both the fabric hueing agent and the surfactant are necessary in their respective proportions in the wash liquor to sufficiently provide the benefits of cleaning the fabric and whitening and/or brightening the fabric. Without wishing to be bound by theory, without the given range of surfactant disclosed by the present invention, the fabric hueing agent is unable to be properly dispersed throughout the wash liquor and will not properly deposit on the fabric thus not enabling a noticeable consumer benefit and/or resulting in the fabric having staining.

Any suitable washing machine may be used. An automatic laundry machine may be used. Those skilled in the art will recognize suitable machines for the relevant wash operation. The unit dose article 1 of the present invention may be used in combination with other compositions, such as fabric additives, fabric softeners, rinse aids and the like.

The wash temperature may be 30° C. or less. The wash process may comprise at least one wash cycle having a duration of between 5 and 20 minutes. The automatic laundry machine may comprise a rotating drum, and wherein during at least one wash cycle, the drum has a rotational speed of between 15 and 40 rpm, preferably between 20 and 35 rpm. The rotating drum having a speed of between 15 and 40 rpm may allow for mechanical movement of the one or more fabrics such that more of the surface area of the one or more fabrics is exposed to the wash liquor.

Water-Soluble Unit-Dose Article

Water-soluble unit dose articles 1 are disclosed herein. The water-soluble unit dose articles 1 may comprise a multi-ply water-soluble fibrous structure. The fibrous structure may comprise one or more plies that are associated with one another to form the water-soluble fibrous structure. The water-soluble fibrous structure may comprise a plurality of fibrous elements 45 that are inter-entangled or otherwise associated with one another to form the plies, and as such, the fibrous structure. Each ply within the fibrous structure may comprise one or more layers, the layers together forming the ply. The layers may comprise the plurality of fibrous elements 45.

FIGS. 1 and 2 show non-limiting examples of water-soluble unit dose articles 1 comprising water-soluble fibrous structure comprising a first ply 5 and a second ply 10 and a plurality of fibrous elements 45. The fibrous structure, fibrous elements 45, plies, and layers are further described hereinafter.

The fibrous structure may comprise at least one fabric hueing agent between the first ply 5 and the second ply 10. The unit dose article 1 may comprise surfactant. In a non-limiting example, the fibrous structure may comprise surfactant between the first ply 5 and the second ply 10. In a non-limiting example, the first ply 5 and/or the second ply 10 and/or any other plies may comprise surfactant.

The unit dose article 1 may be substantially free of surfactant. When the unit dose article 1 is substantially free of surfactant, it is contemplated that the source of the surfactant may be from a source separate from the unit dose article 1, such as from a liquid detergent, powder detergent, and/or sheet detergent. The source of surfactant may be of any source typically used for laundering fabrics.

The unit dose article 1 can be dissolved under various wash conditions, e.g., low temperature, low water and/or short wash cycles and/or cycles where consumers have been overloading the machine. The unit dose articles 1 of the present invention may comprise one or more active agents. As used herein, “active agent” refers to any ingredient that may provide a benefit, either directly or indirectly, to the one or more fabrics. The water-soluble unit dose article 1 may contain insoluble materials, which are dispersible in aqueous wash conditions to a suspension mean particle size that is less than about 20 microns, or less than about 50 microns. The particles may be active containing particles. An advantage of such unit dose articles 1 of the present invention is that the unit dose articles 1 will fully dissolve in aqueous solutions such that any active agents contained within the unit dose article 1 are released into the wash liquor instead of remaining within the substrate of the unit dose article 1. Another advantage of the unit dose articles 1 of the present invention is the straightforward dosing of the unit dose article 1, such that the consumer may place one or more unit dose articles 1 within the washing machine drum without having to measure the product.

The water-soluble unit dose articles may exhibit a thickness of greater than 0.01 mm and/or greater than 0.05 mm and/or greater than 0.1 mm and/or to about 100 mm and/or to about 50 mm and/or to about 20 mm and/or to about 10 mm and/or to about 5 mm and/or to about 2 mm and/or to about 0.5 mm and/or to about 0.3 mm as measured by the Thickness Test Method described herein. In a preferred but not necessary embodiment of the present invention, the unit dose article 1 of the present invention has a rectangular or kite shape. Such a rectangular shape or kite shape is aesthetically pleasing and delightful to the consumers, so multiple articles of such shape can be stacked up and packaged together for sale in a container that is also characterized by a similar rectangular or kite shape.

The water-soluble unit dose articles may have basis weights of from about 500 grams/m² to about 5,000 grams/m², preferably from about 1,000 grams/m² to about 4,000 grams/m², more preferably from about 1,500 grams/m² to about 3,500 grams/m², most preferably from about 2,000 grams/m² to about 3,000 grams/m², as measured according to the Basis Weight Test Method described herein.

Preferably, the unit dose article 1 of the present invention has certain attributes that render it aesthetically pleasing to the consumers. For example, the unit dose article 1 may have a relatively smooth surface provided by the fibrous plies, thereby providing a pleasant feel when touched by the consumer. It is also desirable that the unit dose article 1 of the present invention is strong to withstand substantive mechanical forces without losing its structural integrity, yet at the same time is sufficiently flexible for ease of packaging and storage.

The surface of the water-soluble unit dose article 1 may comprise a printed area. The printed area may cover between about 10% and about 100% of the surface of the unit dose article 1. The area of print may comprise inks, pigments, dyes, blueing agents or mixtures thereof. The area of print may be opaque, translucent or transparent. The area of print may comprise a single color or multiple colors. The printed area maybe on more than one side of the unit dose article 1 and contain instructional text and/or graphics. The surface of the unit dose article 1 may comprise an aversive agent, for example a bittering agent. Suitable bittering agents include, but are not limited to, naringin, sucrose octacetate, quinine hydrochloride, denatonium benzoate, or mixtures thereof. Any suitable level of aversive agent may be used. Suitable levels include, but are not limited to, from about 1 to about 5000 ppm, or even from about 100 to about 2500 ppm, or even from about 250 to about 2000 ppm.

Water-Soluble Fibrous Structure

Water-soluble fibrous structure may comprise one or more plies that are associated with one another to form the water-soluble fibrous structure. The water-soluble fibrous structure may comprise a plurality of fibrous elements 45 that are inter-entangled or otherwise associated with one another to form the plies, and as such, the fibrous structure.

The water-soluble fibrous structure may be comprised of one or more plies. Preferably, the water-soluble fibrous structure is comprised of at least two and/or at least three plies. The water-soluble fibrous structure may comprise at least a first ply 5 and a second ply 10 in juxtaposed relation, wherein the fibrous structure may comprise at least one fabric hueing agent between the first ply 5 and the second ply 10. In a non-limiting example, juxtaposed may mean in a side-by-side relationship. In a non-limiting example, juxtaposed may mean in a facing relationship. Each ply may comprise one or more layers, for example one or more fibrous element layers. Upon addition of the water-soluble unit dose article 1 to an aqueous solution, the water-soluble fibrous structure dissolves and releases any active agents contained within the fibrous structure into the wash liquor.

Each ply may comprise one or more layers, the layers together forming the ply. For instance, as shown in FIG. 3, the fibrous substrate may be comprised of a first ply 5 and a second ply 10, wherein the first ply 5 comprises a first ply outward-facing layer 15 and a first ply inward-facing layer 20 and wherein the second ply 10 comprises a second ply outward-facing layer 30 and a second ply inward-facing layer 25. The plies and layers are further described hereinafter.

The water-soluble fibrous structure may comprise a plurality of identical or substantially identical, from a compositional perspective, of fibrous elements 45. The fibrous structure may comprise two or more different fibrous elements 45. Non-limiting examples of differences in the fibrous elements 45 may be physical differences, such as differences in diameter, length, texture, shape, rigidness, elasticity, and the like; chemical differences, such as crosslinking level, solubility, melting point, Tg, active agent, filament-forming material, color, level of active agent, basis weight, level of filament-forming material, presence of any coating on fibrous element 45, biodegradable or not, hydrophobic or not, contact angle, and the like; differences in whether the fibrous element 45 loses its physical structure when the fibrous element 45 is exposed to conditions of intended use; differences in whether the fibrous element's 45 morphology changes when the fibrous element 45 is exposed to conditions of intended use; and differences in rate at which the fibrous element 45 releases one or more of its active agents when the fibrous element 45 is exposed to conditions of intended use. The fibrous elements 45 may comprise active agents. It is contemplated that any two fibrous elements 45 may comprise different active agents. This may be the case where the different active agents may be incompatible with one another, for example an anionic surfactant and a cationic polymer. When using different fibrous elements 45, the resulting structure may exhibit different wetting, imbibitions, and solubility characteristics. The fibrous elements are described in more detail below.

Fibrous structures can be homogeneous, layered, unitary, zoned, or as otherwise desired, with different active agents defining the various aforesaid portions. The fibrous structure may exhibit different regions, such as different regions of basis weight, density, caliper, and/or wetting characteristics. The fibrous structure may be compressed at the point of edge sealing. The fibrous structure may comprise texture on one or more of its surfaces. A surface of the fibrous structure may comprise a pattern, such as a non-random, repeating pattern. The fibrous structure may be embossed with an emboss pattern. The fibrous structure may comprise apertures. The fibrous structure may comprise discrete regions of fibrous elements 45 that differ from other regions of the composite structure. The plurality of fibrous elements 45 may be arranged within the fibrous structure to provide the fibrous structure with two or more regions that comprise different active agents. For example, one region of the fibrous structure may comprise a fabric hueing agent and another region of the fibrous structure may comprise surfactant.

The fibrous structure of the present invention may be used as is or may be coated with one or more active agents.

Plies and Layers

One or more plies may be associated with one another to form the water-soluble fibrous structure. The water-soluble fibrous structure may comprise a plurality of fibrous elements 45 that are inter-entangled or otherwise associated with one another to form the plies, and as such, the fibrous structure. Each ply within the fibrous structure may comprise one or more layers, the layers together forming the ply. A ply having a plurality of layers can be formed by depositing a plurality of fibrous elements 45 having a distinguishing characteristic to form a first layer and then depositing a second layer of fibrous elements 45 on top of the first layer.

The unit dose article 1 of the present invention may comprise any number of additional plies and any number of additional layers as desired, and such additional plies and/or layers may or may not contain the fabric hueing agent.

The fibrous structure may comprise at least a first ply 5 and a second ply 10. The first ply 5 and the second ply 10 may be in juxtaposed relation. The first ply 5 and the second ply 10 may be in such a configuration as to form an interior 40 of the water-soluble unit dose article 1. The fibrous structure comprises at least one fabric hueing agent between the first ply 5 and the second ply 10.

Fabric hueing agents and other household care active agents may be comprised between the first ply 5 and the second ply 10. Household care active agents may be comprised within the interior 40 formed by the first ply 5 and the second ply 10. The fibrous structure may comprise two plies, preferably three plies. Having two or three or more plies may provide the benefit of placing active agents between the plies such that a consumer does not come into direct contact with the active agents when the consumer handles the unit dose article.

The first ply 5 may comprise at least two superposed layers, a first ply inward-facing layer 20 and a first ply outward-facing layer 15 contiguous with the first ply inward-facing layer 20. The second ply 10 may comprise at least two superposed layers, a second ply inward-facing layer 25 and a second ply outward-facing layer 30 contiguous with the second ply inward-facing layer 25. As shown in FIG. 3, the first ply 5 and the second ply 10 may be oriented in the unit dose article 1 so that the first ply outward-facing layer 15 and the second ply outward-facing layer 30 face away from one another. As further shown in FIG. 3, the first ply 5 and the second ply 10 may be oriented in the unit dose article 1 so that the first ply inward-facing layer 20 and the second ply inward-facing layer 25 may face one another. The first ply 5 and the second ply 10 may be the outermost plies of the unit dose article 1. When the first ply 5 and the second ply 10 are the outermost plies of the unit dose article 1, the first ply outward-facing layer 15 and the second ply outward-facing layer 30 may be the exposed surfaces of the unit dose article 1. The exposed surfaces of the unit dose article 1 may be what the user touches or holds onto in order to transport the unit dose article 1 from one location to another. As exemplified in FIG. 3, the first ply inward-facing layer 20 and the second ply inward-facing layer 25 may form the bounds of the interior 40. Household care active agents may be comprised between the first ply inward-facing layer 20 and the second ply inward-facing layer 25, such as, for example, a fabric hueing agent. Household care active agents may be comprised within the interior 40 formed by the bounds set by the first ply inward-facing layer 20 and the second ply inward-facing layer 25, such as, for example, a fabric hueing agent.

In a preferred example of the present invention, the fibrous substrate comprises at least a first ply 5 and a second ply 10 in juxtaposed relation, the first ply 5 comprising at least two superposed layers, a first ply inward-facing layer 20 and a first ply outward-facing layer 15 contiguous with the first ply inward-facing layer 20, and the second ply 10 comprising at least two superposed layers, a second ply inward-facing layer 25 and a second ply outward-facing layer 30 contiguous with the second ply inward-facing layer 25. The first ply 5 and said second ply 10 may be oriented in the unit dose article 1 so that the first ply outward-facing layer 15 and the second ply outward-facing layer 30 face away from one another and the first ply inward-facing layer 20 and the second ply inward-facing layer 25 face one another. The fibrous structure may comprise a fabric hueing agent between the first ply inward-facing layer 20 and the second ply inward-facing layer 25. The fabric hueing agent may be within particles placed between the first ply inward-facing layer 20 and the second ply inward-facing layer 25. The fabric hueing agent may be comprised within the fibrous elements 45 forming the layers and the plies. When the fibrous elements 45 of the first ply 5 and/or the second ply 10 comprise fabric hueing agent, it is preferred the fibrous elements 45 comprising fabric hueing agent form the first ply inward-facing layer 20 and/or the second ply inward-facing layer 25, and/or any other such layers between the first ply outward-facing layer 15 and the second ply outward-facing layer 30. Although The fabric hueing agent being between the first ply inward-facing layer 20 and the second ply inward-facing layer 25 may provide the benefit of a consumer not coming into contact with the fabric hueing agent when handling the unit dose article 1 and avoiding possible staining of the skin by the fabric hueing agent. If fabric hueing agent is comprised within the fibrous elements 45 forming the first ply outward-facing layer 15 and/or the second ply outward-facing layer 30, there may be a possibility that a consumer may stain their hands when handling the unit dose article 1.

As shown in FIGS. 4 and 5, the fibrous structure may comprise at least a third ply 35 between the first ply 5 and the second ply 10. The fibrous elements 45 of the third ply 35 may comprise fabric hueing agent. The third ply 35 may comprise fibrous elements 45 comprising only fabric hueing agent. The third ply 35 may comprise fibrous elements 45 comprising fabric hueing agent as well as fibrous elements 45 comprising other active agents so long such other active agents do not interfere with the ability of the fabric hueing agent to provide a benefit to the one or more fabrics. The third ply 35 may comprise fibrous elements 45 comprising fabric hueing agent and other active agents so long such other active agents do not interfere with the ability of the fabric hueing agent to provide a benefit to the one or more fabrics. In a non-limiting example, the third ply 35 may comprise fibrous elements 45 comprising fabric hueing agent and surfactant. In a non-limiting example, the third ply 35 may comprise fibrous elements 45 comprising fabric hueing agent and fibrous elements 45 comprising surfactant.

In a preferred example, the first ply 5 and/or the second ply 10 comprise surfactant and the third ply 35 comprises at least one fabric hueing agent, to create a sandwich structure. Without being bound by any theory, it is believed that such a sandwich structure, i.e., with the one or more surfactant-containing plies on both sides and the fabric hueing agent in the middle ply, functions to improve (instead of hinder) dissolution of the fabric hueing agent into the wash liquor during a wash cycle, thereby reducing or eliminating fabric staining or spotting issue typically observed when the fabric hueing agent is provided at a relatively large amount. Further, such a sandwich structure allows a relatively large amount of fabric hueing agent to be incorporated into the finished products in a relatively “invisible” manner, thereby minimizing any negative impact such fabric hueing agent may have upon the overall product appearance.

As shown in FIGS. 6, 7, and 8, any ply may be joined to any other ply to form a unitary unit dose article 1. A portion of any ply may be joined to a portion of any other ply to form a unitary unit dose article 1. As shown in FIG. 6, a portion of the first ply 5 may be joined to a portion of the second ply 10 to form a unitary unit dose article 1. If there is a third ply 35 between the first ply 5 and the second ply 10, the third ply 35 may be contained within the first ply 5 and the second ply 10, as shown in FIG. 7. Optionally, the first ply 5 and the second ply 10 may be joined to the third ply 35 such that the first ply 5 and the second ply 10 are joined to one another through the third ply 35, as shown in FIG. 8. Any such combination joining plies and/or portions thereof may be contemplated for any given number of plies. The plies may be joined either along the periphery thereof, or over the entire ply, or intermittently at certain sections or regions of such plies, so as to enhance the unit dose article's 1 structural integrity. Plies and/or portions thereof can be joined to one another, for instance by using a bonding roll, to form unitary unit dose article 1. Plies and/or portions thereof can be bonded to one another using by thermal bonding. Thermal bonding can be practical if the plies contain thermoplastic powder, optionally water-soluble thermoplastic material. Thermal bonding can also be practical if the fibers constituting the plies are thermoplastic. Plies can optionally be calendar bonded, point bonded, ultrasonically bonded, infrared bonded, through air bonded, needle punched, hydroentangled, melt bonded, adhesive bonded, or other known technical approach for bonding plies of material. Further, the unit dose article 1 can be cut into different shapes, embossed, perforated, printed with different colors or graphic patterns, folded, rolled-up, or otherwise packaged in order to improve its aesthetic appeal and user-friendliness.

Fibrous Elements

The fibrous structure may comprise a plurality of fibrous elements 45. The fibrous elements 45 may be water-soluble. The fibrous elements 45 may comprise constituent material selected from the group consisting of one or more filament forming materials, one or more active agents, and combinations thereof. The active agents may be releasable from the fibrous elements 45, such as when the fibrous element 45 and/or fibrous structure comprising the fibrous element 45 is exposed to conditions of intended use. In a non-limiting example, the fibrous element 45 may releasably comprise one or more active agents. In a non-limiting example, the fibrous element 45 may releasably comprise a hueing dye. In a non-limiting example, the fibrous element 45 may releasably comprise a surfactant.

A fibrous element 45 may comprise one or more filament-forming materials and/or one or more active agents selected from the group consisting of: enzymes, bleaching agents, builder, chelants, sensates, dispersants, perfumes, antimicrobials, antibacterials, antifungals, and mixtures thereof that are releasable and/or released when the fibrous element 45 and/or fibrous structure comprising the fibrous element 45 is exposed to conditions of intended use.

The fibrous elements 45 may comprise from about 5% to about 100% by weight on a dry fibrous element basis and/or dry fibrous structure basis of one or more filament-forming materials. The fibrous elements 45 may comprise from about 5% to about 100% by weight on a dry fibrous element basis and/or dry fibrous structure basis of one or more filament-forming materials and from about 5% to about 95% by weight by weight on a dry fibrous element basis and/or dry fibrous structure basis of one or more active agents. The fibrous elements 45 may comprise more than about 50% by weight on a dry fibrous element basis and/or dry fibrous structure basis of one or more filament-forming materials and less than about 50% by weight on a dry fibrous element basis and/or dry fibrous structure basis of one or more active agents. The fibrous elements may comprise less than about 50% by weight on a dry fibrous element basis and/or dry fibrous structure basis of one or more filament-forming materials and more than about 50% by weight on a dry fibrous element basis and/or dry fibrous structure basis of one or more active agents. The filament-material may be selected from the group consisting of polyvinyl alcohols, starch, cellulosic polymers (e.g., carboxymethylcellulose), polyethylene oxides, and combination thereof. The filament-forming material may have a weight average molecular weight ranging from about 50,000 g/mol to about 3,000,000 g/mol. It is believed that in this range, the filament-forming material may provide extensional rheology, without being so elastic that fiber attenuation is inhibited in the fiber-making process. The fibrous element may further comprise a plasticizer, such as glycerin, and/or pH adjusting agents, such as citric acid. Filament-forming materials are further described hereinafter.

The fibrous element 45 may comprise an active agent within the fibrous element 45 and an active agent on an external surface of the fibrous element 45, such as an active agent coating on the fibrous element 45. The active agent on the external surface of the fibrous element 45 may be the same or different from the active agent present in the fibrous element 45.

The one or more active agents may be uniformly distributed or substantially uniformly distributed throughout the fibrous element 45. The one or more active agents may be distributed as discrete regions within the fibrous element 45. The at least one active agent can be distributed uniformly or substantially uniformly throughout the fibrous element 45 and at least one other active agent is distributed as one or more discrete regions within the fibrous element 45. Optionally, at least one active agent is distributed as one or more discrete regions within the fibrous element 45 and at least one other active agent is distributed as one or more discrete regions different from the first discrete regions within the fibrous element 45.

In the present invention, it is contemplated that each of the fibrous elements 45 of the first ply 5 and/or of the second ply 10 may comprise from about 20% to about 95% by weight on a dry fibrous element basis of surfactant, or at least about 30%, or at least about 40%, or at least about 50%, or at least about 60%, or at least about 70%, by weight on a dry fibrous element basis and/or dry fibrous structure basis of the surfactant. It is further contemplated that the unit dose article 1 may comprise a third ply 35 between the first ply 5 and the second ply 10, wherein each of the fibrous elements 45 of the third ply 35 comprises from about 0.01% to about 30% by weight on a dry fibrous element basis of fabric hueing agent, preferably from about 1% to about 10% by weight on a dry fibrous element basis of fabric hueing agent, more preferably from about 1% to about 5% by weight on a dry fibrous element basis of fabric hueing agent. It is further contemplated that each of the fibrous elements 45 of the first ply 5 and/or of the second ply 10 comprises from about 20% to about 95% by weight on a dry fibrous element basis of surfactant and wherein the unit dose article 1 comprises at least a third ply 35 between the first ply 5 and the second ply 10, wherein each of the fibrous elements 45 of said third ply 35 comprises from about 1% to about 5% by weight on a dry fibrous element basis of fabric hueing agent. The ratio of fabric hueing agent to surfactant in the wash liquor may be from about 1:100 to about 100:1 preferably from about 1:100 to about 1:75 more preferably from about 1:100 to about 1:50, most preferably from about 1:100 to about 1:20. It has been found that such pre-determined amounts of fabric hueing agent and surfactant provide for superior dispersal and deposition of the fabric hueing agent on the one or more fabrics to provide a noticeable consumer benefit of brightening and/or whitening.

The fibrous elements 45 may be meltblown fibrous elements 54, spunbond fibrous elements 54, hollow fibrous elements 54, or the like. The fibrous elements 45 may be hydrophilic or hydrophobic. The fibrous elements 45 may be surface treated and/or internally treated to change the inherent hydrophilic or hydrophobic properties of the fibrous element 45.

In general, fibrous elements 45 are elongated particles having a length greatly exceeding its average cross-sectional diameter. The fibrous elements 45 may have a diameter of less than about 100 μm and/or less than about 75 μm and/or less than about 50 μm and/or less than about 25 μm and/or less than about 10 μm and/or less than about 5 μm and/or less than about 1 μm as measured according to the Diameter Test Method described herein. The fibrous elements 45 may have a diameter of greater than about 1 μm as measured according to the Diameter Test Method described herein. Without wishing to be bound by theory, the smaller the diameter of the fibrous element 45, the faster the rate of release of the active agents and the rate of loss and/or altering of the fibrous element's 45 physical structure. The diameter and length of a fibrous element 45 may be used to control the dissolution and/or release rate of the fabric hueing agent and/or of the active agent(s) present therein, and/or the rate of loss and/or altering of the fibrous element's 45 physical structure.

1. Filament Forming Material in Fibrous Elements

The fibrous elements 45 may comprise constituent material of one or more filament forming materials. The filament-forming material is any suitable material, such as a polymer or monomers capable of producing a polymer that exhibits properties suitable for making a filament, such as by a spinning process. The filament-forming material may comprise a polar solvent-soluble material, such as an alcohol-soluble material and/or a water-soluble material, which can be beneficial for product applications that include use of water. The filament-forming material may comprise a non-polar solvent-soluble material.

The filament-forming material may comprise a water-soluble material and be have less than about 5% and/or less than about 3% and/or less than about 1% and/or about 0% by weight on a dry fibrous element basis and/or dry fibrous structure basis) of water-insoluble materials.

The filament-forming material may comprise a polymer selected from the group consisting of: polymers derived from acrylic monomers such as the ethylenically unsaturated carboxylic monomers and ethylenically unsaturated monomers, polyvinyl alcohol, polyvinylformamide, polyvinylamine, polyacrylates, polymethacrylates, copolymers of acrylic acid and methyl acrylate, polyvinylpyrrolidones, polyalkylene oxides, starch and starch derivatives, pullulan, gelatin, and cellulose derivatives (for example, hydroxypropylmethyl celluloses, methyl celluloses, carboxymethy celluloses).

The filament-forming material may comprise a polymer selected from the group consisting of: polyvinyl alcohol, polyvinyl alcohol derivatives, starch, starch derivatives, cellulose derivatives, hemicellulose, hemicellulose derivatives, proteins, sodium alginate, hydroxypropyl methylcellulose, chitosan, chitosan derivatives, polyethylene glycol, tetramethylene ether glycol, polyvinyl pyrrolidone, hydroxymethyl cellulose, hydroxyethyl cellulose, carboxymethyl cellulose, and mixtures thereof.

The filament-forming material may comprise a polymer is selected from the group consisting of: pullulan, hydroxypropylmethyl cellulose, hydroxyethyl cellulose, hydroxypropyl cellulose, polyvinyl pyrrolidone, carboxymethylcellulose, sodium alginate, xanthan gum, tragacanth gum, guar gum, acacia gum, Arabic gum, polyacrylic acid, methylmethacrylate copolymer, carboxyvinyl polymer, dextrin, pectin, chitin, levan, elsinan, collagen, gelatin, zein, gluten, soy protein, casein, polyvinyl alcohol, carboxylated polyvinyl alcohol, sulfonated polyvinyl alcohol, starch, starch derivatives, hemicellulose, hemicellulose derivatives, proteins, chitosan, chitosan derivatives, polyethylene glycol, tetramethylene ether glycol, hydroxymethyl cellulose, and mixtures thereof.

Non-limiting examples of water-soluble materials include water-soluble polymers. The water-soluble polymers may be synthetic or natural original and may be chemically and/or physically modified.

Non-limiting examples of water-soluble polymers include water-soluble hydroxyl polymers, water-soluble thermoplastic polymers, water-soluble biodegradable polymers, water-soluble non-biodegradable polymers and mixtures thereof. The water-soluble polymer may comprise polyvinyl alcohol. In another example, the water-soluble polymer may comprise starch. The water-soluble polymer may comprise polyvinyl alcohol and starch. The water-soluble polymer may comprise carboxymethyl cellulose. The polymer may compris carboxymethyl cellulose and polyvinyl alcohol.

Non-limiting examples of water-soluble hydroxyl polymers in accordance with the present invention can be selected from the group consisting of polyols, such as polyvinyl alcohol, polyvinyl alcohol derivatives, polyvinyl alcohol copolymers, starch, starch derivatives, starch copolymers, chitosan, chitosan derivatives, chitosan copolymers, cellulose derivatives such as cellulose ether and ester derivatives, cellulose copolymers, hemicellulose, hemicellulose derivatives, hemicellulose copolymers, gums, arabinans, galactans, proteins, carboxymethylcellulose, and various other polysaccharides and mixtures thereof.

Polyvinyl alcohols herein can be grafted with other monomers to modify its properties. A wide range of monomers has been successfully grafted to polyvinyl alcohol. Non-limiting examples of such monomers include vinyl acetate, styrene, acrylamide, acrylic acid, 2-hydroxyethyl methacrylate, acrylonitrile, 1,3-butadiene, methyl methacrylate, methacrylic acid, maleic acid, itaconic acid, sodium vinylsulfonate, sodium allylsulfonate, sodium methylallyl sulfonate, sodium phenylallylether sulfonate, sodium phenylmethallylether sulfonate, 2-acrylamido-methyl propane sulfonic acid (AMPs), vinylidene chloride, vinyl chloride, vinyl amine and a variety of acrylate esters.

In a non-limiting example, the water-soluble hydroxyl polymer is selected from the group consisting of: polyvinyl alcohols, hydroxymethylcelluloses, hydroxyethylcelluloses, hydroxypropylmethylcelluloses, carboxymethylcelluloses, and mixtures thereof. A non-limiting example of a suitable polyvinyl alcohol includes those commercially available from Sekisui Specialty Chemicals America, LLC (Dallas, Tex., USA) under the tradename CELVOL® Polyvinyl Alcohol. Another non-limiting example of a suitable polyvinyl alcohol includes those commercially available from Nippon Gohsei (Arlington Heights, Ill., USA) under the tradename NICHIGO G-POLYMER™. A non-limiting example of a suitable hydroxypropylmethylcellulose includes those commercially available from the Dow Chemical Company (Midland, Mich., USA) under the tradename METHOCEL™ including combinations with above mentioned polyvinyl alcohols.

Non-limiting examples of suitable water-soluble thermoplastic polymers include thermoplastic starch and/or starch derivatives, polylactic acid, polyhydroxyalkanoate, polycaprolactone, polyesteramides and certain polyesters, and mixtures thereof. The water-soluble thermoplastic polymers may be hydrophilic or hydrophobic. The water-soluble thermoplastic polymers may be surface treated and/or internally treated to change the inherent hydrophilic or hydrophobic properties of the thermoplastic polymer. The water-soluble thermoplastic polymers may comprise biodegradable polymers. Any suitable weight average molecular weight for the thermoplastic polymers may be used. For example, the weight average molecular weight for a thermoplastic polymer in accordance with the present invention can be greater than about 10,000 g/mol and/or greater than about 40,000 g/mol and/or greater than about 50,000 g/mol and/or less than about 500,000 g/mol and/or less than about 400,000 g/mol and/or less than about 200,000 g/mol.

2. Active Agents in Fibrous Elements

The fibrous elements 45 may comprise constituent material of one or more active agents. Active agents are a class of additives that are designed and intended to provide a benefit to something other than the fibrous element 45 and/or particle and/or fibrous structure itself, such as providing a benefit to an environment external to the fibrous element 45 and/or particle and/or fibrous structure. The active agent may be selected from the group consisting of: laundry care and/or conditioning agents such as fabric care agents, fabric conditioning agents, fabric softening agents, fabric anti-wrinkling agents, fabric care anti-static agents, fabric care stain removal agents, soil release agents, dispersing agents, suds suppressing agents, suds boosting agents, anti-foam agents, and fabric refreshing agents; other cleaning and/or conditioning agents such as antimicrobial agents, antibacterial agents, antifungal agents, fabric hueing agents, perfume, bleaching agents (such as oxygen bleaching agents, hydrogen peroxide, percarbonate bleaching agents, perborate bleaching agents, chlorine bleaching agents), bleach activating agents, chelating agents, builders, lotions, brightening agents, clay soil removing agents, anti-redeposition agents, polymeric soil release agents, polymeric dispersing agents, alkoxylated polyamine polymers, alkoxylated polycarboxylate polymers, amphiphilic graft copolymers, dissolution aids, buffering systems, water-softening agents, water-hardening agents, pH adjusting agents, enzymes, flocculating agents, effervescent agents, preservatives, deposition aid agents, coacervate-forming agents, clays, thickening agents, latexes, silicas, drying agents, odor control agents, cooling agents, warming agents, absorbent gel agents, anti-inflammatory agents, dyes, pigments, acids, and bases; liquid treatment active agents; water-treatment agents such as water clarifying and/or water disinfecting agents, and mixtures thereof.

In a non-limiting example, the unit dose article 1 of the present invention comprises one or more household care active agents, wherein the household care active agent is selected from the group consisting of a structurant, a builder, an organic polymeric compound, an enzyme, an enzyme stabilizer, a bleach system, a brightener, a chelating agent, a suds suppressor, a conditioning agent, a humectant, a perfume, a perfume microcapsule, a filler or carrier, an alkalinity system, a pH control system, a buffer, an alkanolamine, and mixtures thereof. Any household care active agents known to one skilled in the art that are commonly used in laundry detergents may be contemplated.

Fabric Hueing Agent

The fabric hueing agents used in the present invention may be any colorant that can be formulated into a laundry detergent composition to deposit onto fabrics from the wash liquor so as to provide a benefit to the one or more fabrics, namely a brightness and/or whiteness benefit. The fabric hueing agent may be blue or violet in color, and preferably such fabric hueing agent has a peak absorption wavelength of from about 550 nm to about 650 nm, or from about 570 nm to about 630 nm.

The hueing agent (sometimes referred to as shading, bluing or whitening agents) typically provides a blue or violet shade to fabric. Hueing agents can be used either alone or in combination to create a specific shade of hueing and/or to shade different fabric types. This may be provided for example by mixing a red and green-blue dye to yield a blue or violet shade. Preferably the hueing agent is a blue or violet hueing agent, providing a blue or violet color to a white cloth or fabric. Such a white cloth treated with the composition will have a relative hue angle of from about 210 to about 345, more preferably from about 240 to about 345, more preferably from about 260 to about 325, even more preferably from about 270 to about 310.

In one aspect, a hueing dye suitable for use in the present invention as a hueing agent has, in the wavelength range of about 400 nm to about 750 nm, in methanol solution, a maximum extinction coefficient greater than about 1000 liter/mol/cm. In one aspect, a hueing dye suitable for use in the present invention has, in the wavelength range of about 540 nm to about 650 nm, a maximum extinction coefficient from about 10,000 to about 100,000 liter/mol/cm. In one aspect, a hueing dye suitable for use in the present invention has, in the wavelength range of about 570 nm to about 630 nm, a maximum extinction coefficient from about 20,000 to about 70,000 liter/mol/cm or even about 100,000 liter/mol/cm.

In a non-limiting example, the one or more fabric hueing agents of the present invention may be selected from the group consisting of dyes, dye-clay conjugates, organic pigments, inorganic pigments, optical brightener, and combinations thereof. Preferably, the one or more fabric hueing agents is a fabric hueing dye, preferably selected from the group consisting of direct dyes, basic dyes, reactive dyes, solvent dyes, disperse dyes, and combinations thereof. Such materials are known to provide brightening and/or whitening benefit when used in laundry detergents.

Dyes are typically colored organic molecules which are soluble in aqueous media that contain surfactants (in contrast with pigments which are typically not soluble in aqueous media). Dyes may include small molecule dyes and polymeric dyes. The hueing agent may be selected from any chemical class of dye as known in the art, including but not limited to acridine, anthraquinone (including polycyclic quinones), azine, azo (e.g., monoazo, disazo, trisazo, tetrakisazo, polyazo), benzodifurane, benzodifuranone, carotenoid, coumarin, cyanine, diazahemicyanine, diphenylmethane, formazan, hemicyanine, indigoids, methane, naphthalimides, naphthoquinone, nitro, nitroso, oxazine, phthalocyanine, pyrazoles, stilbene, styryl, triarylmethane, triphenylmethane, xanthenes and mixtures thereof.

Suitable small molecule dyes maybe selected from the group consisting of direct dyes, basic dyes, reactive dyes, solvent dyes, disperse dyes, and combinations thereof. More preferably, suitable small molecular dyes may be selected from the group consisting of dyes falling into the Color Index (C.I.) classifications of Direct Blue, Direct Violet, Acid Blue, Acid Violet, Basic Blue, Basic Violet, and mixtures thereof. Examples of suitable dyes are Violet DD, Direct Violet 7, Direct Violet 9, Direct Violet 11, Direct Violet 26, Direct Violet 31, Direct Violet 35, Direct Violet 40, Direct Violet 41, Direct Violet 51, Direct Violet 66, Direct Violet 99, Acid Violet 50, Acid Blue 9, Acid Violet 17, Acid Blue 29, Solvent Violet 13, Disperse Violet 27 Disperse Violet 26, Disperse Violet 28, Disperse Violet 63, Disperse Violet 77, Basic Blue 16, Basic Blue 65, Basic Blue 66, Basic Blue 67, Basic Blue 71, Basic Blue 159, Basic Violet 19, Basic Violet 35, Basic Violet 38, Basic Violet 48, Basic Blue 3, Basic Blue 75, Basic Blue 95, Basic Blue 122, Basic Blue 124, Basic Blue 141, Reactive Blue 19, Reactive Blue 163, Reactive Blue 182, Reactive Blue 96, thiazolium dyes, commercially available under the tradename LIQUITINT® Violet CT (commercially available from Milliken, S.C., USA) and Azo-CM-Cellulose (commercially available from Megazyme, Bray, Republic of Ireland). Other suitable hueing agents are hueing dye-photobleach conjugates, such as the conjugate of sulphonated zinc phthalocyanine with Direct Violet 99. A particularly suitable hueing agent is a combination of Acid Red 52 and Acid Blue 80, or the combination of Direct Violet 9 and Solvent Violet 13.

In a non-limiting example of the present invention, the fabric hueing agent has the following chemical structure:

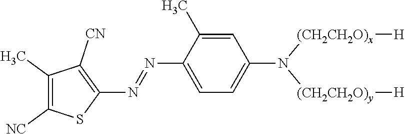

wherein the index values x and y are independently selected from 1 to 10. This fabric hueing agent is commercially available from Milliken Chemical (South Carolina, USA) under the tradename LIQUITINT® Violet 200.

In another preferred embodiment of the present invention, the fabric hueing agent has the following structure:

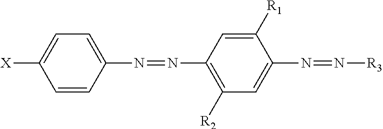

wherein: R₁ and R₂ are independently selected from the group consisting of: H; alkyl; alkoxy; alkyleneoxy; alkyl capped alkyleneoxy; urea; and amido; R₃ is a substituted aryl group; X is a substituted group comprising sulfonamide moiety and optionally an alkyl and/or aryl moiety, and wherein the substituent group comprises at least one alkyleneoxy chain that comprises an average molar distribution of at least four alkyleneoxy moieties.

Optical brighteners are another group of compounds that can be used to achieve fabric hueing benefit, either alone or in combination with the dyes described hereinabove. Suitable optical brighteners may include, but are not limited to: diaminostilbenes, distyrylbiphenyls, and combinations thereof. Preferably, such fluorescent dyes are selected from the group consisting of disodium 4,4′-bis{[4-anilino-6-morpholino-s-triazin-2-yl]-amino}-2,2′-stilbenedisulfonate (also referred to as “Fluorescent Brightener 260”), disodium 4,4″-bis[(4,6-di-anilino-s-triazin-2-yl)-amino]-2,2′-stilbenedisulfonate, disodium 4,4′-bis{[4-anilino-6-[bis(2-hydroxyethyl)amino-s-triazin-2-yl] amino}-2,2′-stilbenedisulfonate, disodium 2,2′-([1,1′-biphenyl]-4,4′diyldivinylene)bis (benzenesulphonate) and combinations thereof. The fabric hueing agent may be an optical brightener selected from the group consisting of: diaminostilbenes, distyrylbiphenyls, and combinations thereof. A particularly preferred optical brightener to be incorporated into the unitary laundry detergent article of the present invention is disodium 2,2′-([1,1′-biphenyl]-4,4′diyldivinylene)bis (benzenesulphonate). The optical brightener may be in micronized particulate form, having a weight average particle size in the range of from about 3 to about 30 micrometers, or from about 3 micrometers to about 20 micrometers, or from about 3 to about 10 micrometers. The optical brightener can also be in an alpha or beta crystalline form.

In a non-limiting example, materials suitable for incorporation into the benefit agent containing delivery particles of the present invention include leuco dyes, antioxidants, and mixtures thereof. Leuco dyes are known in the prior art to exhibit a change from a colorless or slightly colored state to a colored state upon exposure to specific chemical or physical triggers. The chemical or physical triggers that bring about the coloration change include, but are not limited to, oxidation, intramolecular ring opening, pH change, and exposure to heat and/or cold or light (e.g. UV light). Preferred Leuco dyes include those that develop a color upon triggering that is suitable for use as a shading dye to increase whiteness perception. Triarylmethane compounds are a class of leuco dyes useful in one aspect. In one aspect, materials suitable for incorporation into the unitary laundry detergent article of the present invention include leuco dyes, antioxidants, and mixtures thereof. Leuco dyes are known to exhibit a change from a colorless or slightly colored state to a colored state upon exposure to specific chemical or physical triggers. The chemical or physical triggers that bring about the coloration change include, but are not limited to, oxidation, intramolecular ring opening, pH change, and exposure to heat and/or cold or light (e.g., UV light). Preferred Leuco dyes include those that develop a color upon triggering that is suitable for use as a hueing agent to increase whiteness perception. Triarylmethane and triphenylmethane compounds are a class of leuco dyes particularly useful in one aspect.

The Test Methods provided herein can be used to determine if a hueing agent, or a mixture of hueing agents, is a hueing agent for the purposes of the present invention.

Surfactant

The method of laundering a fabric may comprise the step of providing a surfactant. The unit dose article 1 may comprise a surfactant. The unit dose article 1 may be substantially free of surfactant.

The surfactant may be selected from the group consisting of anionic surfactants, cationic surfactants, nonionic surfactants, zwitterionic surfactants, amphoteric surfactants, ampholytic surfactants, and mixtures thereof. Preferably, the surfactant is an anionic surfactant. Even more preferably, the surfactant is selected from the group consisting of linear or branched alkyl benzene sulfonates, linear or branched alkyl sulfates, and mixtures thereof.

1. Anionic Surfactant

Suitable anionic surfactants may exist in an acid form, and the acid form may be neutralized to form a surfactant salt. Typical agents for neutralization include metal counterion bases, such as hydroxides, e.g., NaOH or KOH. Further suitable agents for neutralizing anionic surfactants in their acid forms include ammonia, amines, or alkanolamines Non-limiting examples of alkanolamines include monoethanolamine, diethanolamine, triethanolamine, and other linear or branched alkanolamines known in the art; suitable alkanolamines include 2-amino-1-propanol, 1-aminopropanol, monoisopropanolamine, or 1-amino-3-propanol Amine neutralization may be done to a full or partial extent, e.g., part of the anionic surfactant mix may be neutralized with sodium or potassium and part of the anionic surfactant mix may be neutralized with amines or alkanolamines.

Anionic surfactants may be supplemented with salt as a means to regulate phase behavior; suitable salts may be selected from the group consisting of sodium sulfate, magnesium sulfate, sodium carbonate, sodium citrate, sodium silicate, and mixtures thereof.

Non-limiting examples of suitable anionic surfactants include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. Suitable anionic surfactants may be derived from renewable resources, waste, petroleum, or mixtures thereof. Suitable anionic surfactants may be linear, partially branched, branched, or mixtures thereof

Alkoxylated alkyl sulfate materials comprise ethoxylated alkyl sulfate surfactants, also known as alkyl ether sulfates or alkyl polyethoxylate sulfates. Examples of ethoxylated alkyl sulfates include water-soluble salts, particularly the alkali metal, ammonium and alkylolammonium salts, of organic sulfuric reaction products having in their molecular structure an alkyl group containing from about 8 to about 30 carbon atoms and a sulfonic acid and its salts. (Included in the term “alkyl” is the alkyl portion of acyl groups. In some examples, the alkyl group contains from about 15 carbon atoms to about 30 carbon atoms. In other examples, the alkyl ether sulfate surfactant may be a mixture of alkyl ether sulfates, said mixture having an average (arithmetic mean) carbon chain length within the range of about 12 to 30 carbon atoms, and in some examples an average carbon chain length of about 12 to 15 carbon atoms, and an average (arithmetic mean) degree of ethoxylation of from about 1 mol to 4 mols of ethylene oxide, and in some examples an average (arithmetic mean) degree of ethoxylation of 1.8 mols of ethylene oxide. In further examples, the alkyl ether sulfate surfactant may have a carbon chain length between about 10 carbon atoms to about 18 carbon atoms, and a degree of ethoxylation of from about 1 to about 6 mols of ethylene oxide. In yet further examples, the alkyl ether sulfate surfactant may contain a peaked ethoxylate distribution.

Non-alkoxylated alkyl sulfates may also be added to the disclosed detergent compositions and used as an anionic surfactant component. Examples of non-alkoxylated, e.g., non-ethoxylated, alkyl sulfate surfactants include those produced by the sulfation of higher C₈-C₂₀ fatty alcohols. In some examples, primary alkyl sulfate surfactants have the general formula: ROSO₃⁻M⁺, wherein R is typically a linear C₈-C₂₀ hydrocarbyl group, which may be straight chain or branched chain, and M is a water-solubilizing cation. In some examples, R is a C₁₀-C₁₈ alkyl, and M is an alkali metal. In other examples, R is a C₁₂/C₁₄ alkyl and M is sodium, such as those derived from natural alcohols.

Other useful anionic surfactants can include the alkali metal salts of alkyl benzene sulfonates, in which the alkyl group contains from about 9 to about 15 carbon atoms, in straight chain (linear) or branched chain configuration. In some examples, the alkyl group is linear. Such linear alkylbenzene sulfonates are known as “LAS.” In other examples, the linear alkylbenzene sulfonate may have an average number of carbon atoms in the alkyl group of from about 11 to 14. In a specific example, the linear straight chain alkyl benzene sulfonates may have an average number of carbon atoms in the alkyl group of about 11.8 carbon atoms, which may be abbreviated as C11.8 LAS.

Suitable alkyl benzene sulphonate (LAS) may be obtained, by sulphonating commercially available linear alkyl benzene (LAB); suitable LAB includes low 2-phenyl LAB, such as those commercially available by Sasol (Johannesburg, South Africa) under the tradename ISOCHEM® or those supplied by Petresa (Quebec, Canada) under the tradename PETRELAB®, other suitable LAB include high 2-phenyl LAB, such as those supplied by Sasol (Johannesburg, South Africa) under the tradename HYBLENE®. In one aspect a magnesium salt of LAS is used.

In a preferred example, the surfactant is characterized by a Hydrophilic Index (HI) of no more than 7.5, and the surfactant is selected from the group consisting of C₆-C₂₀ linear alkylbenzene sulfonates (LAS), C₆-C₂₀ linear or branched alkyl sulfates (AS), and a combination thereof. In a preferred example, the surfactant is an unalkoxylated C₆-C₁₈ linear or branched AS surfactant, most preferably an unalkoxylated C₁₂-C₁₄ linear or branched AS surfactant.

Another example of a suitable alkyl benzene sulfonate is a modified LAS (MLAS), which is a positional isomer that contains a branch, e.g., a methyl branch, where the aromatic ring is attached to the 2 or 3 position of the alkyl chain.

The anionic surfactant may include a 2-alkyl branched primary alkyl sulfates have 100% branching at the C2 position (C1 is the carbon atom covalently attached to the alkoxylated sulfate moiety). 2-alkyl branched alkyl sulfates and 2-alkyl branched alkyl alkoxy sulfates are generally derived from 2-alkyl branched alcohols (as hydrophobes). 2-alkyl branched alcohols, e.g., 2-alkyl-1-alkanols or 2-alkyl primary alcohols, which are derived from the oxo process, are commercially available from Sasol (Johannesburg, South Africa), e.g., under the tradenames LIAL®, ISALCHEM® (which is prepared from LIAL® alcohols by a fractionation process). C14/C15 branched primary alkyl sulfate are also commercially available, e.g., namely under the tradename LIAL® 145 sulfate.

The anionic surfactant may include a mid-chain branched anionic surfactant, e.g., a mid-chain branched anionic detersive surfactant, such as, a mid-chain branched alkyl sulphate and/or a mid-chain branched alkyl benzene sulphonate.

Additional suitable anionic surfactants include methyl ester sulfonates, paraffin sulfonates, α-olefin sulfonates, and internal olefin sulfonates.

Nonionic Surfactant

Suitable nonionic surfactants include alkoxylated fatty alcohols. The nonionic surfactant may be selected from ethoxylated alcohols and ethoxylated alkyl phenols of the formula R(OC₂H₄)ₙ,OH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

Other non-limiting examples of nonionic surfactants useful herein include: C₈-C₁₈ alkyl ethoxylates, such as commercially available from Shell (USA) under the tradename NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as commercially available from BASF (Cincinnati, Ohio, USA) under the tradename PLURONIC®; C₁₄-C₂₂ mid-chain branched alcohols, BA; C₁₄-C₂₂ mid-chain branched alkyl alkoxylates, BAEₓ, wherein x is from 1 to 30; alkylpolysaccharides; specifically alkylpolyglycosides; polyhydroxy fatty acid amides; and ether capped poly(oxyalkylated) alcohol surfactants.

Suitable nonionic detersive surfactants also include alkyl polyglucoside and alkyl alkoxylated alcohol. Suitable nonionic surfactants also include those commercially available from BASF (Cincinnati, Ohio, USA) under the tradename the tradename LUTENSOL®.

Cationic Surfactant

Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, e.g., amido propyldimethyl amine (APA).

Suitable cationic detersive surfactants also include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, for example chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Zwitterionic Surfactant

Suitable zwitterionic surfactants include: derivatives of secondary and tertiary amines, derivatives of heterocyclic secondary and tertiary amines, or derivatives of quaternary ammonium, quaternary phosphonium or tertiary sulfonium compounds. Suitable examples of zwitterionic surfactants include betaines, including alkyl dimethyl betaine and cocodimethyl amidopropyl betaine, C₈ to C₁₈ (for example from C₁₂ to C₁₈) amine oxides, and sulfo and hydroxy betaines, such as N-alkyl-N,N-dimethylammino-1-propane sulfonate where the alkyl group can be C₈ to C₁₈.

Amphoteric Surfactant

Suitable amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g., carboxy, sulfonate, sulfate. Suitable amphoteric surfactants also include sarcosinates, glycinates, taurinates, and mixtures thereof.

Particles

Optionally, household care active agents may be incorporated into or onto discrete water-soluble particles, which are in turn sandwiched between the above-described plies. In the present invention, fabric hueing agent is incorporated through the plurality of fibrous elements 45, however, it is contemplated that fabric hueing agent may also be incorporated in the unit dose article 1 by way of particles in addition to the fabric hueing agent comprised in the plurality of fibrous elements 45. The unit dose article 1 disclosed herein may comprise one or more particles distributed throughout the fibrous structure. The particles may contain soluble and/or insoluble material, where the insoluble material is dispersible in aqueous wash conditions to a suspension mean particle size that is less than about 20 microns.

The particle may be a powder, granule, agglomerate, encapsulate, microcapsule, and/or prill. The particle may be made using a number of well known methods in the art, such as spray-drying, agglomeration, extrusion, prilling, encapsulation, pastillation and combinations thereof. The shape of the particle can be in the form of spheres, rods, plates, tubes, squares, rectangles, discs, stars, fibers or have regular or irregular random forms.

The size distribution of the particle, as characterized according to the Granular Size Distribution Test Method, may have a D50 greater than about 150 μm and less than about 1600 um, or a D50 greater than 205 μm and less than about 1000 μm, or a D50 greater than about 300 um and a D90 less than about 850 μm, or a D50 greater than about 350 μm and less than about 700 μm.

The size distribution of the particle, as characterized according to the Granular Size Distribution Test Method, may have a D20 greater than about 150 μm and a D80 less than about 1400 μm, or a D20 greater than about 200 μm and a D80 less than about 1180 μm, or a D20 greater than about 250 μm and a D80 less than about 1000 μm.

The size distribution of the particle, as characterized according to the Granular Size Distribution Test Method, may have a D10 greater than about 150 μm and a D90 less than about 1400 μm, or a D10 greater than about 200 μm and a D90 less than about 1180 μm, or a D10 greater than about 250 μm and a D90 less than about 1000 μm.

The particles may be the same or different. The particles may be solid, free-flowing particles. The particles may comprise a fully formulated laundry detergent composition or a portion thereof, such as a spray-dried, extruded or agglomerate particle that forms part of a laundry detergent composition. The unit dose article 1 disclosed herein may comprise a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Method of Making Water-Soluble Layers and Plies

Water-soluble layers and plies of the present invention can be made as follows. A filament-forming composition may be spun into one or more fibrous elements and/or particles by any suitable spinning process, such as meltblowing, spunbonding, electro-spinning, and/or rotary spinning. The filament-forming composition may be spun into a plurality of fibrous elements and/or particles by meltblowing. The filament-forming composition may be spun through a die block assembly having one or more spinning beams. Each spinning beam may form a plurality of fibrous elements or a plurality of particles having incorporated one or more active agents into the filament melt, or filament-forming composition, e.g., a fabric hueing agent or a surfactant. During the spinning process, the filament-forming composition is attenuated with air to create one or more fibrous elements and/or particles. The fibrous elements and/or particles may then be dried to remove any remaining solvent used for spinning, such as the water. The fibrous elements and/or particles of the present invention may be collected on a collection belt, such as a patterned belt or flat belt, to form a fibrous structure comprising the fibrous elements and/or particles that are directed into the fibrous elements. Such fibrous structure may be a layer.

A layer may be formed of a plurality of fibrous elements. A plurality of fibrous elements is formed and upon exiting a spinning die, is collected on a collection belt moving in the machine direction.

Particles can be incorporated into a water-soluble unit dose article several different ways. A layer may be formed of a plurality of fibrous elements and particles co-impinged into the plurality of fibrous elements to create a composite structure where the particle packing is dilated and fibrous elements substantially inter-penetrate the inter-particle porosity. Such particles can be introduced into the stream of the fibrous elements between the die block assembly and the collection belt. To form the composite fibrous element and particle fibrous structure, a plurality of fibrous elements is formed and upon exiting a first spinning die, is collected on a collection belt moving in the machine direction. The collection belt having the plurality of fibrous elements then passes under a second spinning beam that is modified with a particle addition system. The particle addition system is capable of substantially injecting particles toward a landing zone on the collection belt that is directly under the fibrous elements from the second spinning beam. Suitable particle addition systems may be assembled from a particle feeder, such as a vibratory, belt or screw feeder, and an injection system, such as an air knife or other fluidized conveying system. In order to aid in a consistent distribution of particles in the cross direction, the particles are preferably fed across about the same width as the spinning die to ensure particles are delivered across the full width of the composite structure. Preferably, the particle feeder is completely enclosed with the exception of the exit to minimize disruption of the particle feed.

Optionally, one or more particles may be sandwiched between the above-described layers and/or plies formed of multiple layers. Particles can be introduced after the fibrous elements are deposited on the collection belt. Such particles may not be suitable for passing through the spinning process. Such particles may be applied to the fibrous elements and/or fibrous structure comprising the fibrous elements after the fibrous elements and/or fibrous structure have been formed. Such particles may reside between layers. The particle packing is not sufficiently dilated and the fibrous elements do not substantially inter-penetrate the inter-particle porosity in such cases. The one or more particles may be associated with the fibrous structure and may be provided by a particle addition source, for example a sifter, belt feeder, or a airlaid forming head. Such particles may be formed by processes including, but not limited to, granulation by extrusion/cutting, extrusion/spheronization, agglomeration, spray-drying, layering, and combinations thereof.

Multilayer plies can be formed by providing two die block assemblies, one die block assembly downstream of another die block assembly. A first layer of fibrous elements and/or particles may be formed by providing a solution of a filament-forming composition and spinning the filament-forming composition within a first die block assembly having one or more spinning dies and one or more fiber-spinning beams, forming a plurality of fibrous elements, such as filaments, and incorporating one or more active agents into the filament melt, or filament-forming composition. The fibrous elements are collected on the collection belt and move in the machine direction. In layers containing particles, the collection belt having the first layer of fibrous elements then passes under a second spinning beam of the first die block assembly that is modified with a particle addition system. The particle addition system is capable of substantially injecting particles toward a landing zone on the collection belt that is directly under the fibrous elements from the second spinning beam. In layers free of particles, the collection belt having the first layer of fibrous elements then moves along in the machine direction and passes under a second spinning beam. A second solution of a filament-forming composition may be provided and the filament-forming composition may be spun from the spinning beam within a second die block assembly to form a second plurality of fibrous elements, such as filaments, and incorporating one or more active agents into the filament melt, or filament-forming composition. The second plurality of fibrous elements is then deposited on top of the first layer on the collection belt. As noted above, the second layer may contain particles as described, or may be free of particles. The two layers, or layered composite structure, may together form a ply. The process may be repeated any number of times until the desired number of layers forming the ply is reached.

The collection belt may be patterned in order to impart a texture, such as a three-dimensional texture, to at least one surface of the structure. Optionally, one or more particles may be associated with the fibrous structure in between any of the layers formed.

### Method of Making a Water-Soluble Unit Dose Article

A first ply may be joined to a second ply separate the first ply, to form a water-soluble unit dose article. The first ply and second ply may be superposed relative to one another. By superposed, it is meant that the first ply is positioned above or below the second ply. As discussed above, any number of particles may be introduced between the plies according to the exemplary processes described above.

A portion of the first ply and a portion of the second ply, can be joined to one another, for instance by using a bonding roll, to form the water-soluble unit dose article. There may be a third, fourth, fifth, or any number of separate plies contained between the first ply and second ply. Optionally, the first ply and the second ply can be joined to a third ply so that the first ply and the second ply are joined to one another through the third ply. Preferably, the two or more plies are joined to one another at the edges of the plies, such as to create an edge seal, such that any particles distributed on top of and/or between fibrous plies and/or within layers do not leak out of the water-soluble unit dose article. Sealing may inhibit the leakage of particles as well as to help the water-soluble unit dose article maintain its original structure. The water-soluble unit dose article may be compressed at the point of edge sealing. In a non-limiting example, a first ply and the second ply may each comprise a fibrous layer comprising a plurality fibrous elements and void of particles, and a fibrous layer comprising both a plurality of fibrous elements and a plurality of particles. The fibrous layers void of particles may be placed as the outward facing surfaces of the water-soluble unit dose article and the layers having particles may be placed as inward facing surfaces of the water-soluble unit dose article 5.

Plies can be joined, or bonded, to one another by thermal bonding. Thermal bonding can be practical if the plies contain thermoplastic powder, optionally water-soluble thermoplastic material. Thermal bonding can also be practical if the fibers constituting the plies are thermoplastic. Plies can optionally be calendar bonded, point bonded, ultrasonically bonded, infrared bonded, through air bonded, needle punched, hydroentangled, melt bonded, adhesive bonded, or other known technical approach for bonding plies of material.

### Test Methods

### Thickness Test Method

Article thickness is measured by measuring the thickness caliper of the article using—Check-Line® (by Electromatic) digital thickness guage, Model #J-40-V, where the thickness is measured at the geometric center of the article.

### Basis Weight Test Method

Basis weight of a fibrous structure is measured on stacks of twelve usable units using a top loading analytical balance with a resolution of ±0.001 g. The balance is protected from air drafts and other disturbances using a draft shield. A precision cutting die, measuring 3.500 in ±0.0035 in by 3.500 in ±0.0035 in is used to prepare all samples.

With a precision cutting die, cut the samples into squares. Combine the cut squares to form a stack twelve samples thick. Measure the mass of the sample stack and record the result to the nearest 0.001 g.

The Basis Weight is calculated in lbs/3000 ft² or g/m² as follows:

Basis Weight=(Mass of stack)/[(Area of 1 square in stack)×(No.of squares in stack)]

For example,

Basis Weight (lbs/3000 ft²)=[[Mass of stack (g)/453.6 (g/lbs)]/[12.25 (int)/144 (int/ft²)×12]]×3000

or,

Basis Weight (g/m²)=Mass of stack (g)/[79.032 (cm²)/10,000 (cm²/m²)×12]

Report result to the nearest 0.1 lbs/3000 ft² or 0.1 g/m². Sample dimensions can be changed or varied using a similar precision cutter as mentioned above, so as at least 100 square inches of sample area in stack.

### Diameter Test Method

The diameter of a discrete fibrous element or a fibrous element within a fibrous structure is determined by using a Scanning Electron Microscope (SEM) or an Optical Microscope and an image analysis software. A magnification of 200 to 10,000 times is chosen such that the fibrous elements are suitably enlarged for measurement. When using the SEM, the samples are sputtered with gold or a palladium compound to avoid electric charging and vibrations of the fibrous element in the electron beam. A manual procedure for determining the fibrous element diameters is used from the image (on monitor screen) taken with the SEM or the optical microscope. Using a mouse and a cursor tool, the edge of a randomly selected fibrous element is sought and then measured across its width (i.e., perpendicular to fibrous element direction at that point) to the other edge of the fibrous element. A scaled and calibrated image analysis tool provides the scaling to get actual reading in um. For fibrous elements within a fibrous structure, several fibrous elements are randomly selected across the sample of the fibrous structure using the SEM or the optical microscope. At least two portions of the fibrous structure are cut and tested in this manner. Altogether at least 100 such measurements are made and then all data are recorded for statistical analysis. The recorded data are used to calculate average (mean) of the fibrous element diameters, standard deviation of the fibrous element diameters, and median of the fibrous element diameters.

Another useful statistic is the calculation of the amount of the population of fibrous elements that is below a certain upper limit. To determine this statistic, the software is programmed to count how many results of the fibrous element diameters are below an upper limit and that count (divided by total number of data and multiplied by 100%) is reported in percent as percent below the upper limit, such as percent below 1 micrometer diameter or %-submicron, for example. We denote the measured diameter (in μm) of an individual circular fibrous element as di.

In the case that the fibrous elements have non-circular cross-sections, the measurement of the fibrous element diameter is determined as and set equal to the hydraulic diameter which is four times the cross-sectional area of the fibrous element divided by the perimeter of the cross-section of the fibrous element (outer perimeter in case of hollow fibrous elements). The number-average diameter, alternatively average diameter is calculated as:

$${d}_{num} = \frac{{\sum }_{i = 1}^{n} {d}_{i}}{n}$$

### Granular Size Distribution Test Method

The granular size distribution test is conducted to determine characteristic sizes of particles. It is conducted using ASTM D 502-89, “Standard Test Method for Particle Size of Soaps and Other Detergents”, approved May 26, 1989, with a further specification for sieve sizes and sieve time used in the analysis. Following section 7, “Procedure using machine-sieving method,” a nest of clean dry sieves containing U.S. Standard (ASTM E 11) sieves #4 (4.75 mm), #6 (3.35 mm), #8 (2.36 mm), #12 (1.7 mm), #16 (1.18 mm), #20 (850 um), #30 (600 um), #40 (425 um), #50 (300 um), #70 (212 um), #100 (150 um) is required to cover the range of particle sizes referenced herein. The prescribed Machine-Sieving Method is used with the above sieve nest. A suitable sieve-shaking machine can be obtained from W.S. Tyler Company, Ohio, U.S.A. The sieve-shaking test sample is approximately 100 grams and is shaken for 5 minutes.

The data are plotted on a semi-log plot with the micron size opening of each sieve plotted against the logarithmic abscissa and the cumulative mass percent (Q₃) plotted against the linear ordinate. An example of the above data representation is given in ISO 9276-1:1998, “Representation of results of particle size analysis—Part 1: Graphical Representation”, Figure A.4. A characteristic particle size (Dx), for this invention, is defined as the abscissa value at the point where the cumulative mass percent is equal to x percent, and is calculated by a straight-line interpolation between the data points directly above (a) and below (b) the x % value using the following equation:

Dx=10̂[Log(Da)−(Log(Da)−Log(Db))*(Qa−x %)/(Qa−Qb)]

where Log is the base-10 logarithm, Qa and Qb are the cumulative mass percentile values of the measured data immediately above and below the xth percentile, respectively; and Da and Db are the micron sieve size values corresponding to these data.
Example data and calculations:

| sieve size | weight on sieve | cumulative mass % finer |
|---|---|---|
| (um) | (g) | (CMPF) |
| 4750 | 0 | 100% |
| 3350 | 0 | 100% |
| 2360 | 0 | 100% |
| 1700 | 0 | 100% |
| 1180 | 0.68 | 99.3% |
| 850 | 10.40 | 89.0% |
| 600 | 28.73 | 60.3% |
| 425 | 27.97 | 32.4% |
| 300 | 17.20 | 15.2% |
| 212 | 8.42 | 6.8% |
| 150 | 4.00 | 2.8% |
| pan | 2.84 | 0.0% |

For D10 (x=10%), the micron screen size where CMPF is immediately above 10% (Da) is 300 um, the screen below (Db) is 212 um. The cumulative mass immediately above 10% (Qa) is 15.2%, below (Qb) is 6.8%.

D10=10̂[Log(300)−(Log(300)−Log(212))*(15.2%−10%)/(15.2%−6.8%)]=242 um

For D50 (x=50%), the micron screen size where CMPF is immediately above 50% (Da) is 1180 um, the screen below (Db) is 850 um. The cumulative mass immediately above 90% (Qa) is 99.3%, below (Qb) is 89.0%.

D50=10̂[Log(600)−(Log(600)−Log(425))*(60.3%−50%)/(60.3%−32.4%)]=528 μm

For D90 (x=90%), the micron screen size where CMPF is immediately above 90% (Da) is 600 um, the screen below (Db) is 425 um. The cumulative mass immediately above 50% (Qa) is 60.3%, below (Qb) is 32.4%.

D90=10̂[Log(1180)−(Log(1180)−Log(850))*(99.3%−90%)/(99.3%−89.0%)]=878 um

### Determination of Fabric Hueing Agents

Test 1: Method for Determining Fabric Deposition of a Hueing Agent
a) Un-brightened Multifiber Fabric Style 41 swatches (MFF41, 5 cm×10 cm, average weight 1.46 g) serged with un-brightened thread are purchased from Testfabrics, Inc. (West Pittston, Pa.). MFF41 swatches are stripped prior to use by washing two full cycles in AATCC heavy duty liquid laundry detergent (HDL) nil brightener at 49° C. and washing 3 additional full cycles at 49° C. without detergent. Four replicate swatches are placed into each flask.
b) A sufficient volume of AATCC standard nil brightener HDL detergent solution is prepared by dissolving the detergent in 0 gpg water at room temperature at a concentration of 1.55 g per liter.
c) A concentrated stock solution of hueing agent is prepared in an appropriate solvent selected from dimethyl sulfoxide (DMSO), ethanol or 50:50 ethanol:water. Ethanol is preferred. The hueing agent stock is added to a beaker containing 400 mL detergent solution (prepared in step I.b. above) in an amount sufficient to produce an aqueous solution absorbance at the λₘₐₓ of 0.1 AU(±0.01AU) in a cuvette of path length 1.0 cm. For a mixture of hueing agents, the agents are to be tested in the same relative proportions as found in the unitary laundry detergent article, and the sum of the aqueous solution absorbance at the λₘₐₓ of the individual dyes is 0.1 AU(±0.01AU) in a cuvette of path length 1.0 cm. Total organic solvent concentration in a wash solution from the concentrated stock solution is less than 0.5%. A 125 mL aliquot of the wash solution is placed into three (3) disposable 250 mL Erlenmeyer flasks (Thermo Fisher Scientific, Rochester, N.Y.).
d) Four MFF41 swatches are placed into each flask, flasks are capped and manually shaken to wet the swatches. Flasks are placed onto a Model 75 wrist action shaker from Burrell Scientific, Inc. (Pittsburg, Pa.) and agitated on the highest setting of 10 (390 oscillations per minute with an arc of 14.6°). After 12 minutes, the wash solution is removed by vacuum aspiration, 125 mL of 0 gpg water is added for a rinse, and the flasks agitated for 4 additional minutes. Rinse solution is removed by vacuum aspiration and swatches are spun in a Mini Countertop Spin Dryer (The Laundry Alternative Inc., Nashua, N.H.) for 5 minutes, after which they are allowed to air dry in the dark.
e) L*, a*, and b* values for the 3 most consumer-relevant fabric types, cotton, nylon, and polyester, are measured on the dry swatches using a LabScan XE reflectance spectrophotometer (HunterLabs, Reston, Va.; D65 illumination, 10° observer, UV light excluded). The L*, a*, and b* values of the 12 swatches (3 flasks each containing 4 swatches) are averaged and the hueing deposition (HD) of the hueing agent is calculated for each fabric type using the following equation:

HD=DE*=((L*_{c}−L*ₛ)²+(a*_{c}−a*ₛ)²+(b*_{c}−b*ₛ)²)^{1/2}

wherein the subscripts c and s respectively refer to the control, i.e., the fabric washed in detergent with no hueing agent, and the fabric washed in detergent containing hueing agent, or a mixture of hueing agents, according to the method described above.

Test 2: Method for Determining Relative Hue Angle (vs. Nil Dye Control)
a) The a* and b* values of the 12 swatches from each solution are averaged and the following formulas are used to determine Δa* and Δb*:

Δa*=a*_{c}−a*and Δb*=b*c−b*s

wherein the subscripts c and s respectively refer to the fabric washed in detergent with no hueing agent and the fabric washed in detergent containing hueing agent, or mixture of hueing agents, according to the method described in Test 1: Method for Determining Fabric Deposition of a Material hereinabove.
b) If the absolute value of both Δa* and Δb*<0.25, no Relative Hue Angle (RHA) is calculated. If the absolute value of either Δa* or Δb* are >0.25, the RHA is determined using one of the following formulas:

When Δb*>0, RHA=A TAN 2(Δa*,Δb*)

When Δb*<0, RHA=360+A TAN 2(Δa*,Δb*)

A material, or a mixture of materials, is considered a hueing agent for the purposes of the present invention if: (a) either the HD_{cotton} or the HD_{polyester} is greater than or equal to 2.0 DE* units, preferably greater than or equal to 3.0, more preferably greater than or equal to 4.0, most preferably greater than or equal to 5.0, as determined by Test 1: Method for Determining Fabric Deposition of a Material method hereabove; and (b) the relative hue angle on the fabric that meets the DE* criterion in (a) is from 210 to 345, preferably from 240 to 345, more preferably from 260 to 325, most preferably from 270 to 310, as determined by the Test 2: Method for Determining Relative Hue Angle (vs. Nil Dye Control) hereinabove. If the values of HD for both fabric types are less than 2.0 DE* units, or if the relative hue angle is not within the prescribed range on at least one fabric for which the DE* meets the criteria, the respective material is then not considered a fabric hueing agent for the purposes of the present invention.

### Staining Visual Observation Protocol

The Staining Visual Observation Protocol is conducted to determine whether or not there is noticeable staining on the fabrics tested. Fabrics are visually observed prior to treatment to determine whether there exists any initial staining. Fabrics having initial staining are placed aside and not used for this protocol. Fabrics undergo a wash/dry cycle using a standard washing machine and a standard drying machine. The number of wash/dry cycles undergone may vary. A control may be conducted by having the fabrics undergo a wash/dry cycle without any treatment. In other wash/dry cycles, the fabric may be added to the washing machine along with a treatment of fabric hueing agent additive without detergent or a treatment of fabric hueing agent additive with detergent. After a wash/dry cycle, the fabrics are removed from the drying machine and examined for noticeable areas of staining.

### EXAMPLES

### Example 1

A first layer is formed by providing a solution of a filament-forming composition and spinning the filament-forming composition from a spinning die having one or more spinning beams, forming a plurality of fibrous elements, such as filaments, and incorporating one or more active agents into the filament melt, or filament-forming composition. A plurality of particles may also be formed by providing a solution of a filament-forming composition and spinning the filament-forming composition from a spinning die having one or more spinning beams. The particles may be co-impinged into the plurality of fibrous elements to create a composite structure where the particle packing is dilated and fibrous elements substantially inter-penetrate the inter-particle porosity. The plurality of fibrous elements and plurality of particles are then deposited onto a collection belt to form a layer.

Table 1 below sets forth non-limiting examples of layers formed of fibrous elements and/or particles of the present invention. To make the fibrous elements, an aqueous solution, preferably having about 45% to 60% solids content, is processed through one or more spinning beams, as discussed above. A suitable spinning beam comprises a capillary die with attenuation airflow, along with drying airflow suitable to substantially dry the attenuated fibers before their impingement on the collection belt. For layers containing particles, the co-impingement of particles and fibrous elements on the collection belt under the spinning beams creates a composite fibrous element/particle structure.

TABLE 1
Fibrous Layers (FL) Compositions, mass %

| Component | FL-1 | FL-2 | FL-3 |
|---|---|---|---|
| NaAS | 0.00 | 0.00 | 5.89 |
| NaAE₁S | 0.00 | 0.00 | 15.69 |
| NaLAS (from fiber) | 0.00 | 0.00 | 11.77 |
| NaLAS (from particle) | 0.00 | 0.00 | 6.88 |
| Polyethyleneimine (PE) 20 | 0.00 | 0.00 | 2.66 |
| Polyethylene Glycol (PEG) 4000 | 0.00 | 0.00 | 5.98 |
| Sodium carbonate | 0.00 | 0.00 | 11.12 |
| Zeolite | 0.00 | 0.00 | 23.24 |
| ACUSOL ™ 588 | 0.00 | 0.00 | 0.00 |
| Fluorescent brightener 49 | 0.00 | 0.00 | 0.00 |
| LIQUITINT ® Violet 200 | 5.00 | 0.00 | 0.00 |
| AOT-70 | 0.92 | 0.97 | 0.00 |
| Malic acid | 0.22 | 0.23 | 0.00 |
| AMIOCA ® starch | 91.65 | 96.59 | 0.00 |
| Polyvinyl alcohol 505 | 0.00 | 0.00 | 8.01 |
| PEOn10 | 0.00 | 0.00 | 0.71 |
| PEOn6000 | 0.00 | 0.00 | 0.11 |
| Misc. & Moisture* | 2.21 | 2.21 | 7.95 |
| Layer total | 100.00 | 100.00 | 100.00 |
| g/m² | 150 | 90 | 967 |

As shown in Table 1, fibrous layer FL-1 comprises a hueing dye agent (LIQUITINT Violet 200). Fibrous layer FL-1 does not comprise surfactant. Fibrous layer FL-2 does not comprise neither a hueing dye agent nor a surfactant. Fibrous layer FL-3 comprises a surfactant but does not comprise a hueing dye agent.

FL-3 is a composite fibrous element and particle layer. FL-3 is composed of 72.69 wt. % particles and 27.31 wt. % fibers. The particles are composed of: NaAE1S 21.58 wt. %; NaLAS 9.47 wt. %; PE20 3.65 wt. %; PEG4000 8.22 wt. %; sodium carbonate 15.29 wt. %; zeolite 31.97 wt. %; misc. & moisture 9.81 wt %. The fibers are composed of: NaAS 21.56 wt. %; NaLAS 43.11 wt. %; PVOH 505 29.33 wt. %; PEOn10 2.60 wt. %; PEOn6000 0.40 wt. %; and misc. & moisture 3.00 wt. %; and 264 g/m².

Resulting products, water-soluble unit dose articles, are exemplified in Table 2, providing structural detail for product chasses by layer components (from Tables 1), with the net chassis composition for the product. Note that other product adjunct materials such as perfume, enzymes, suds suppressors, bleaching agents, etc. may be added to a chassis. Chases exemplify a range of water-soluble unit dose articles of the present disclosure. The number of layers is provided for each chassis. The layers may be single-layer plies.

TABLE 2
Product chasses (C), mass %

| Chassis | C-1 | C-2 |
|---|---|---|
| FL-1 No. of Layers | 1 | 1 |
| FL-2 No. of Layers | 0 | 2 |
| FL-3 No. of Layers | 3 | 0 |
| Chassis total area (m²) | 0.0056 | 0.0033 |
| Formula, wt % | | |
| NaAS | 3.88 | 0.00 |
| NaAE₁S | 10.33 | 0.00 |
| NaLAS (from fiber) | 7.76 | 0.00 |
| NaLAS (from particle) | 4.53 | 0.00 |
| Polyethyleneimine (PE) 20 | 1.75 | 0.00 |
| Polyethylene Glycol (PEG) | 3.94 | 0.00 |
| Sodium carbonate | 7.32 | 0.00 |
| Zeolite | 15.31 | 0.00 |
| ACUSOL ™ 588 | 0.00 | 0.00 |
| Fluorescent brightener 49 | 0.00 | 0.00 |
| LIQUITINT ® Violet 200 | 0.17 | 2.03 |
| AOT-70 | 0.03 | 0.85 |
| Malic acid | 0.01 | 0.20 |
| AMIOCA ® starch | 3.12 | 84.28 |
| Polyvinyl alcohol 505 | 5.28 | 0.00 |
| PEOn10 | 0.47 | 0.00 |
| PEOn6000 | 0.07 | 0.00 |
| Misc. & Moisture* | 5.31 | 1.97 |
| Additional components** | 30.72 | 10.66 |
| Chassis Total | 100.00 | 100.00 |

As shown in Table 2, chassis C-1 comprises both surfactant and a hueing dye agent. Chassis C-2 comprises a hueing dye agent but does not comprise surfactant.

### Raw Materials for Example 1

NaAS is a C₁₂₋₁₄ sulfate, sodium salt, supplied by Stepan, Northfield, Ill., USA, and/or a mid-branched alkyl sulfate.
NaAES is alkyl ethoxy sulfate, sodium salt, supplied by Stepan, Northfield, Ill., USA or Shell Chemicals, Houston, Tex., USA.
NaLAS is linear alkyl benzene sulfonate, sodium salt, supplied by Stepan, Northfield, Ill., USA or Huntsman Corp.
ACUSOL™ 588 is a water-soluble copolymer supplied as the partially neutralized sodium salt in water, supplied by DOW CHEMICAL, Midland, Mich., USA.
LIQUITINT® Violet 200 is a water-soluble polymeric colorant supplied by Milliken Chemical, Spartanburg, S.C., USA.
AOT-70 is a docusate sodium salt supplied by Sigma-Aldrich, St. Louis, Mo.
PEO is polyethylene oxide.
PE20 is an ethoxylated polyethyleneimine
Misc. & Moisture may include any additional actives plus residual moisture, process aids, and trace salt and unreacted alcohols in surfactant paste.
Additional components may include components added after the fibrous layers were formed. Such components include, but are not limited to: neat perfume, Polyethylene Glycol (PEG) 8000, perfume microcapsules, FINNFIX®2 CMC (supplied by CP Kelco, Atlanta, Ga., USA), NaCl, PLURAFAC® SLF-18 (supplied by BASF, Cincinnati, Ohio, USA); ink; linear alkyl benzene sulfonate (LAS) particle; methylglycine diacetic acid (MGDA) particle (80% active); one or more suds suppressors; STAINZYME® (supplied by Novozyme, Denmark); and/or Fluorescent brightener 49.

### Example 2

### Treatment of Fabrics with Fabric Hueing Agent Additive and with Surfactant Provides Fewer to No Incidences of Staining When Compared with Treatment of Fabrics with Fabric Hueing Agent without Surfactant

Example 2 demonstrates the effect of the method of the present disclosure, the treatment of fabrics with a fibrous structure comprising at least one fabric hueing agent, the treatment further comprising the addition of a surfactant, on fabrics such that there is fewer to no incidences of staining when compared with the treatment of fabrics with a fibrous structure comprising at least one fabric hueing agent and no surfactant.

Twelve new white Gildan shirts (100% cotton, short sleeve t-shirts, size: XL) were used as the fabrics in Example 3. The fabrics were placed in a Kenmore 600 Series standard top loader washing machine. The Kenmore washing machine was set to average size wash load (17 gallons) with water set at 90° F. wash cycle, 60° F. rinse cycle, the water having 6 gpg hardness. 50 grams of TIDE® Original Scent liquid detergent (purchased in Cincinnati, Ohio, 2017) was weighed and poured on top of the fabrics. A 50 gram dose of TIDE® Original Scent liquid detergent contains 129 ppm total surfactant (AES/HLAS/NI). A fibrous substrate having a fabric hueing agent was placed on top of the fabrics. The wash cycle having normal agitation and one rinse cycle was then completed. The fabrics were removed from the washing machine and were placed in a Kenmore standard Kenmore 80 series drying machine, model 110.64832400, serial MR4534318. The Kenmore drying machine was set to the cotton setting. The fabrics were then dried under the cotton setting with heat for 30 minutes. The fabrics were removed from the drying machine and visually observed under the Staining Visual Observation Protocol for any noticeable areas of staining

The test was then repeated using twelve new white Gildan shirts. The same washing machine and drying machine types were used. A fibrous substrate having a fabric hueing agent was placed on top of the fabrics. No detergent was added. The fabrics then underwent the same cycles and procedure as the fabrics treated with both TIDE® Original Scent liquid detergent and with the fibrous substrate having a fabric hueing agent. The fabrics were removed from the drying machine and visually observed under the Staining Visual Observation Protocol for any noticeable areas of staining.

It was found that the twelve fabrics that underwent the wash/dry cycle with treatment of detergent along with the fibrous substrate having a fabric hueing agent resulted in no incidences of staining on any of the twelve fabrics. It was found that the twelve fabrics that underwent the wash/dry cycle with treatment of fibrous substrate having a fabric hueing agent with no addition of detergent resulted in 25% of the fabrics having incidences of staining. As such, it has been found that the invention of the present disclosure results in fewer to no incidences of staining on fabrics undergoing wash/dry cycles as described above.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering fabric comprising the steps of:
a. providing a water-soluble unit dose article comprising a multi-ply water-soluble fibrous structure comprising a plurality of fibrous elements, said fibrous structure comprising at least a first ply and a second ply in juxtaposed relation, wherein said fibrous structure comprises at least one fabric hueing agent between said first ply and said second ply;
b. providing a surfactant;
c. diluting a dose of said water-soluble unit dose article in water by a factor of greater than about 500 to form a wash liquor, the resulting wash liquor comprising from about 50 ppm to about 2800 ppm of surfactant; and
d. washing one or more fabrics with said wash liquor.

2. The method of laundering fabric according to claim 1, wherein said unit dose article comprises said surfactant.

3. The method of laundering fabric according to claim 1, wherein said unit dose article is substantially free of said surfactant.

4. The method of laundering fabric according to claim 1, wherein said first ply comprises at least two superposed layers, a first ply inward-facing layer and a first ply outward-facing layer contiguous with said first ply inward-facing layer, and wherein said second ply comprises at least two superposed layers, a second ply inward-facing layer and a second ply outward-facing layer contiguous with said second ply inward-facing layer, said first ply and said second ply being oriented in said unit dose article so that said first ply outward-facing layer and said second ply outward-facing layer face away from one another and said first ply inward-facing layer and said second ply inward-facing layer face one another, wherein said fabric hueing agent is between said first ply inward-facing layer and said second ply inward-facing layer.

5. The method according to claim 4, wherein each of said fibrous elements of said first ply and/or of said second ply comprises from about 20% to about 75% by weight on a dry fibrous element basis of said surfactant.

6. The method of laundering fabric according to claim 4, wherein said unit dose article comprises at least a third ply between said first ply and said second ply, wherein each of said fibrous elements of said third ply comprises from about 0.01% to about 30% by weight on a dry fibrous element basis of said fabric hueing agent.

7. The method according to claim 4, wherein each of said fibrous elements of said first ply and/or of said second ply comprises from about 20% to about 95% by weight on a dry fibrous element basis of surfactant and wherein said unit dose article comprises at least a third ply between said first ply and said second ply, wherein each of said fibrous elements of said third ply comprises from about 0.01% to about 30% by weight on a dry fibrous element basis of said fabric hueing agent.

8. The method of laundering fabric according to claim 1, wherein the ratio of said fabric hueing agent to said surfactant in said wash liquor is from about 1:100 to about 100:1.

9. The method of laundering fabric according to claim 1, wherein said at least one fabric hueing agent is selected from the group consisting of dyes, dye-clay conjugates, organic pigments, inorganic pigments, optical brighteners, and combinations thereof, wherein the fabric hueing agent provides a relative hue angle to white fabric of from about 210 to about 345.

10. The method of laundering fabric according to claim 1, wherein said fabric hueing agent has a chemical structure of: 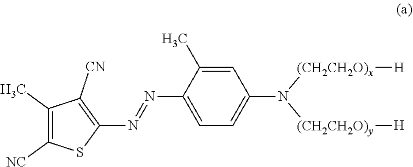
wherein the index values x and y are independently selected from 1 to 10; or 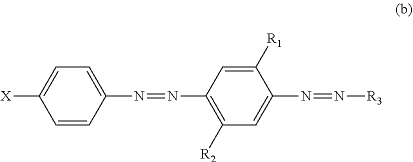
wherein: R1 and R2 are independently selected from the group consisting of: H; alkyl; alkoxy; alkyleneoxy; alkyl capped alkyleneoxy; urea; and amido; R3 is a substituted aryl group; X is a substituted group comprising sulfonamide moiety and optionally an alkyl and/or aryl moiety, and wherein the substituent group comprises at least one alkyleneoxy chain that comprises an average molar distribution of at least four alkyleneoxy moieties.

11. The method of laundering fabric according to claim 1, wherein said fabric hueing agent is an optical brightener, wherein said optical brightener is selected from the group consisting of diaminostilbenes, distyrylbiphenyls, and combinations thereof.

12. The method of laundering fabric according to claim 1, wherein said surfactant is selected from the group consisting of anionic surfactants, cationic surfactants, nonionic surfactants, zwitterionic surfactants, amphoteric surfactants, and mixtures thereof.

13. The method of laundering fabric according to claim 1, wherein said surfactant is characterized by a Hydrophilic Index (HI) of no more than 7.5, and wherein said surfactant is selected from the group consisting of C₆-C₂₀ linear alkylbenzene sulfonates (LAS), C₆-C₂₀ linear or branched alkyl sulfates (AS), and a combination thereof.

14. The method of laundering fabric according to claim 1, wherein said unit dose article further comprises one or more household care active agents, wherein said household care active agent is selected from the group consisting of a structurant, a builder, an organic polymeric compound, an enzyme, an enzyme stabilizer, a bleach system, a brightener, a chelating agent, a suds suppressor, a conditioning agent, a humectant, a perfume, a perfume microcapsule, a filler or carrier, an alkalinity system, a pH control system, a buffer, an alkanolamine, and mixtures thereof.

15. A water-soluble unit dose article comprising a multi-ply water-soluble fibrous structure comprising a plurality of fibrous elements, said fibrous structure comprising at least a first ply and a second ply in juxtaposed relation, said first ply comprising at least two superposed layers, a first ply inward-facing layer and a first ply outward-facing layer contiguous with said first ply inward-facing layer, and said second ply comprising at least two superposed layers, a second ply inward-facing layer and a second ply outward-facing layer contiguous with said second ply inward-facing layer, said first ply and said second ply being oriented in said unit dose article so that said first ply outward-facing layer and said second ply outward-facing layer face away from one another and said first ply inward-facing layer and said second ply inward-facing layer face one another, and wherein said fibrous structure further comprises a fabric hueing agent between said first ply inward-facing layer and said second ply inward-facing layer.

16. The water-soluble unit dose article according to claim 15, wherein each of said fibrous elements of said first ply and/or of said second ply comprises from about 20% to about 95% by weight on a dry fibrous element basis of a surfactant and wherein said unit dose article comprises at least a third ply between said first ply and said second ply, wherein each of said fibrous elements of said third ply comprises from about 0.01% to about 30% by weight on a dry fibrous element basis of said fabric hueing agent.

17. A water-soluble unit dose article comprising a multi-ply water-soluble fibrous structure comprising a plurality of fibrous elements, said fibrous structure comprising at least a first ply and a second ply in juxtaposed relation, said first ply comprising at least two superposed layers, a first ply inward-facing layer and a first ply outward-facing layer contiguous with said first ply inward-facing layer, and said second ply comprising at least two superposed layers, a second ply inward-facing layer and a second ply outward-facing layer contiguous with said second ply inward-facing layer, said first ply and said second ply being oriented in said unit dose article so that said first ply outward-facing layer and said second ply outward-facing layer face away from one another and said first ply inward-facing layer and said second ply inward-facing layer face one another, and wherein said fibrous structure comprises a fabric hueing agent between said first ply inward-facing layer and said second ply inward-facing layer and wherein said fibrous structure further comprises a surfactant.

18. A water-soluble unit dose article according to claim 17, wherein each of said fibrous elements of said first ply and/or of said second ply comprises from about 20% to about 95% by weight on a dry fibrous element basis of surfactant.

19. A water-soluble unit dose article according to claim 18, wherein the ratio of said fabric hueing agent to said surfactant in said unit dose article is from about 1:100 to about 100:1.

20. A water-soluble unit dose article according to claim 17, wherein said first ply and/or a portion thereof is joined to said second ply and/or a portion thereof.
